(19) United States
(12) Patent Application Publication
(10) Pub. No.: US 2026/0129071 A1
(43) Pub. Date: May 7, 2026

(54) DYNAMICALLY GENERATING OPERATIONAL TECHNOLOGY ASSET GROUPINGS FOR HEALTH AND SECURITY ANALYSIS

(71) Applicant: Darktrace Holdings Limited, Cambridge (GB)

(72) Inventors: Samuel Goldsmith, Norfolk (GB); Jack Pearson, Cambridge (GB); Ajeck Ndifon, Cambridge (GB); Thomas Preston, Cambridge (GB)

(21) Appl. No.: 19/426,880

(22) Filed: Dec. 19, 2025

Related U.S. Application Data
(63) Continuation-in-part of application No. 19/242,732, filed on Jun. 18, 2025.
Application No. 19/242,732 is a continuation of application No. 18/387,322, filed on Nov. 6, 2023, now Pat. No. 12,363,157.
Application No. 18/387,322 is a continuation of application No. 16/278,953, filed on Feb. 19, 2019, now Pat. No. 11,843,628.
(60) Provisional application No. 62/632,623, filed on Feb. 20, 2018.
(60) Provisional application No. 63/736,488, filed on Dec. 19, 2024.

(51) Int. Cl. H04L 9/40; G06F 3/04842; G06F 3/0486; G06F 16/2455; G06F 18/23; G06F 18/232; G06F 21/36; G06F 21/55; G06F 40/40; G06N 20/00; G06N 20/10; G06N 20/20; G06V 30/10; H04L 41/22; H04L 43/045; H04L 51/212; H04L 51/224; H04L 51/42

(52) U.S. Cl. CPC H04L 63/1441; G06F 3/04842; G06F 3/0486; G06F 16/2455; G06F 18/23; G06F 18/232; G06F 21/36; G06F 21/554; G06F 21/556; G06F 40/40; G06N 20/00; G06N 20/10; G06V 30/10; H04L 41/22; H04L 43/045; H04L 51/212; H04L 51/42; H04L 63/0209; H04L 63/0428; H04L 63/101; H04L 63/14; H04L 63/1416; H04L 63/1425; H04L 63/1433; H04L 63/1483; G06N 20/20; H04L 51/224; H04L 63/20

(57) ABSTRACT

Systems, methods, and apparatus are disclosed for analyzing Operational Technology (OT) networks. A cyber security appliance includes an OT module to receive data from a plurality of OT assets. An asset identification module passively monitors data to identify asset properties and generate a human-readable label for each OT asset. One or more machine-learning models are trained on a normal pattern of life for the plurality of OT assets. A comparator module compares network data to the normal pattern of life to detect anomalous activity, distinguishing between cyber threats and operational health issues, such as an absence of expected communication, and generates distinct alerts for each. An architecture generation module uses the labels to apply a grouping, such as by shared characteristic or user-defined filter, creating one or more asset groupings and generating visualization data for presentation on a display.

### CLAIM FOR PRIORITY

This application claims the benefit under 35 USC § 119 of provisional Application Ser. No. 63/736,488 filed on Dec. 19, 2024, as well as the benefit of priority under 35 USC 120 as a continuation in part patent application from U.S. patent application Ser. No. 19/242,732 filed Jun. 18, 2025, titled ‘A CYBER SECURITY APPLIANCE FOR AN OPERATIONAL TECHNOLOGY NETWORK,’ as well as the benefit of priority under 35 USC 120 as a continuation patent application from U.S. patent application Ser. No. 18/387,322 filed Nov. 6, 2023, titled ‘A CYBER SECURITY APPLIANCE FOR AN OPERATIONAL TECHNOLOGY NETWORK,’ which claims the benefit of priority under 35 USC 120 from U.S. patent application Ser. No. 16/278,953 filed Feb. 19, 2019, titled ‘A CYBER SECURITY APPLIANCE FOR AN OPERATIONAL TECHNOLOGY NETWORK,’ which claims priority to and the benefit of under 35 USC 119 of U.S. provisional patent application titled “A cyber threat defense system with various improvements,” filed Feb. 20, 2018, Ser. No. 62/632,623, which are all hereby expressly incorporated by reference in their entirety for all purposes.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### FIELD

Embodiments of the design provided herein generally relate to cyber security and the monitoring of operational technology (OT) networks.

### BACKGROUND

Computer networks have become essential to modern enterprise operations, interconnecting a vast array of computing devices, servers, and databases. These Information Technology (IT) networks facilitate communication and data transfer, but their complexity and the value of the data they carry also make them significant targets for malicious actors. Cybersecurity threats, such as malware and unauthorized access attempts, constantly evolve, posing a persistent risk to network integrity and data confidentiality. Consequently, network security monitoring has become a critical field, focusing on analyzing network traffic to detect anomalous activities that may indicate a cyber threat.

Beyond traditional IT environments, many industrial sectors also rely heavily on Operational Technology (OT) networks. These networks are typically found in settings such as manufacturing facilities, power plants, and other industrial control systems. OT networks are used to monitor and control physical machinery and processes, often utilizing specialized devices like Programmable Logic Controllers (PLCs). The communication protocols used within these OT environments are often distinct from standard internet protocols (IP) and are tailored for specific industrial tasks.

Historically, IT and OT networks were often isolated from one another. However, modern operational demands have led to increasing convergence, where IT networks are connected to OT networks to provide updates, remote monitoring, and data analytics. This IT/OT convergence, while beneficial for business efficiency, creates significant security vulnerabilities. A cyber threat that successfully infiltrates the IT network may be able to “cross over” and send malicious commands to the OT network, potentially causing physical disruption, damaging machinery, or halting critical infrastructure operations.

Monitoring these complex, converged environments presents a substantial challenge for network administrators and security teams. Security personnel may be experts in IT threats but often have less familiarity with the specialized protocols and operational behaviors of OT assets. Furthermore, the sheer number of devices in a modern enterprise, spanning both IT and OT domains, makes it difficult to maintain a clear and accurate inventory or understand the complex web of interactions between them.

### SUMMARY

Methods, systems, and apparatus are disclosed for an Artificial Intelligence-based cyber security system. The Artificial Intelligence based (AI-based) cyber security system may include many features including the following twenty concepts.

In an embodiment, a cyber security appliance, includes a processing component, and a non-transitory computer readable medium including one or more software modules accessible by the processing component, the one or more software modules include an operational technology (OT) module configured to receive data from an OT network, the data associated with a plurality of OT assets, an asset identification module configured to passively monitor the data to identify one or more properties of the plurality of OT assets and generate a human-readable label for each of the plurality of OT assets based on the identified one or more properties, one or more machine-learning models trained on a normal pattern of life for the plurality of OT assets based on data received by the OT module, a comparator module configured to compare data received from the OT network to the normal pattern of life for the plurality of OT assets to detect anomalous activity, and an architecture generation module configured to receive the human-readable labels for the plurality of OT assets from the asset identification module, apply a grouping to the plurality of OT assets to create one or more asset groupings, and generate architecture visualization data representing the one or more asset groupings.

In an embodiment, a cyber security appliance further includes a user interface module configured to receive the architecture visualization data and present the one or more asset groupings on a display.

In an embodiment, the grouping is configured to identify a shared characteristic among the plurality of OT assets.

In an embodiment, the shared characteristic is selected from a group consisting of a shared manufacturer, a shared device type, a shared communication protocol, and a shared subnet.

In an embodiment, the grouping includes a user-defined filter applied to the plurality of OT assets.

In an embodiment, the asset identification module is configured to generate the human-readable label by extracting an asset identifier from communication packets associated with an OT asset, determining a vendor associated with the asset identifier, and applying a priority-based rule set to the determined vendor and other identified properties to generate the human-readable label.

In an embodiment, the asset identifier is a Media Access Control (MAC) address.

In an embodiment, the comparator module is further configured to distinguish between anomalous activity indicative of a cyber threat and anomalous activity indicative of an operational health issue, in response to detecting a cyber threat, generate a cyber threat alert, and in response to detecting an operational health issue, generate an operational health alert.

In an embodiment, the comparator module is configured to generate the operational health alert by monitoring an OT asset for an expected communication based on the asset's normal pattern of life, determining that an operational time window has expired, and generating the operational health alert in response to detecting an absence of the expected communication within the expired operational time window.

In an embodiment, the comparator module is configured to generate the operational health alert by retrieving a stored operational state for an OT asset, monitoring communication packets from the OT asset to detect a current operational state, and generating the operational health alert in response to determining the current operational state is different from the stored operational state.

In an embodiment, a method for visualizing a network includes receiving, by a cyber security appliance, data associated with a plurality of operational technology (OT) assets from an OT network, passively monitoring the data to identify one or more properties of the plurality of OT assets, generating a human-readable label for each of the plurality of OT assets based on the identified one or more properties, referencing one or more machine-learning models trained on a normal pattern of life for the plurality of OT assets, comparing data received from the OT network to the normal pattern of life to detect anomalous activity, applying a grouping to the plurality of OT assets to create one or more asset groupings, generating architecture visualization data representing the one or more asset groupings, and presenting the one or more asset groupings on a graphical user interface dashboard.

In an embodiment, the one or more properties of the method are selected from a group consisting of an observed communication protocol, an identified device type, and a determined subnet.

In an embodiment, generating the human-readable label includes applying a priority-based rule set to the identified one or more properties.

In an embodiment, the priority-based rule set is configured to generate a specific label by combining two or more of the identified properties selected from the group, and wherein the specific label is prioritized over a generic network identifier associated with the OT asset.

In an embodiment, passively monitoring the data includes parsing an internet protocol (IP) traffic payload from a gateway device to identify a sub-device address associated with an OT asset lacking a direct IP address, and creating a virtual asset associated with the sub-device address to be monitored as a unique asset.

In an embodiment, applying the grouping includes receiving a user-defined filter from an operator, and applying the user-defined filter to the plurality of OT assets to create the one or more asset groupings.

In an embodiment, a non-transitory computer readable medium including software modules to be executed by a processor include an operational technology (OT) module configured to receive data from an OT network, the data associated with a plurality of OT assets, an asset identification module configured to passively monitor the data to identify one or more properties of the plurality of OT assets and generate a human-readable label for each of the plurality of OT assets based on the identified one or more properties, a comparator module configured to cooperate with one or more machine-learning models trained on a normal pattern of life for the plurality of OT assets to detect anomalous activity, an architecture generation module configured to apply a grouping to the plurality of OT assets to create one or more asset groupings, and generate architecture visualization data representing the one or more asset groupings, and a user interface module configured to receive the architecture visualization data and present the one or more asset groupings on a display.

In an embodiment, the asset identification module is configured to generate the human-readable label by extracting an asset identifier from communication packets, querying a locally stored database with the asset identifier to determine a vendor, and applying a priority-based rule set to the determined vendor and other identified properties to generate the human-readable label.

In an embodiment, the comparator module is further configured to generate a cyber threat alert in response to detecting anomalous activity indicative of a cyber threat, and generate an operational health alert in response to detecting anomalous activity indicative of an operational health issue.

In an embodiment, the user interface module is further configured to present both the cyber threat alert and the operational health alert on a unified dashboard displayed on a common display screen.

### DRAWINGS

The drawings refer to an embodiment of the design provided herein in which:

The above, and other, aspects, features, and advantages of an embodiment of the present disclosure will be more apparent from the following description as presented in conjunction with the following several figures of the drawings.

FIG. 1 is a diagram of a network environment, in accordance with an embodiment of the disclosure;

FIG. 2 is a diagram of an exemplary industrial environment, in accordance with an embodiment of the disclosure;

FIG. 3 is a block diagram of a cybersecurity appliance, in accordance with an embodiment of the disclosure;

FIG. 4 is a block diagram of an operational overview system architecture, in accordance with an embodiment of the disclosure;

FIG. 5 is an exemplary user interface dashboard, in accordance with an embodiment of the disclosure;

FIG. 6 is an exemplary user interface for asset management, in accordance with an embodiment of the disclosure;

FIG. 7 is an exemplary user interface for operational alerts, in accordance with an embodiment of the disclosure;

FIG. 8 is a block diagram of a cloud security analytics subsystem, in accordance with an embodiment of the disclosure;

FIG. 9 is another diagram of an exemplary industrial environment, in accordance with an embodiment of the disclosure;

FIG. 10 is a diagram of the Purdue Model for industrial control systems, in accordance with an embodiment of the disclosure;

FIG. 11 is a flowchart of an overall process for cybersecurity and operational health analysis, in accordance with an embodiment of the disclosure;

FIG. 12 is a flowchart of a process for asset identification and labeling, in accordance with an embodiment of the disclosure;

FIG. 13 is a flowchart of a process for virtual asset creation, in accordance with an embodiment of the disclosure;

FIG. 14 is a flowchart of a process for detecting device offline status, in accordance with an embodiment of the disclosure;

FIG. 15 is a flowchart of a process for operational state change alerts, in accordance with an embodiment of the disclosure;

FIG. 16 is a flowchart of a process for generating architecture visualization data, in accordance with an embodiment of the disclosure;

FIG. 17 is a flowchart of a process for monitoring IT/OT convergence, in accordance with an embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

While the design is subject to various modifications, equivalents, and alternative forms, specific embodiments thereof have been shown by way of example in the drawings and will now be described in detail. It should be understood that the design is not limited to the particular embodiments disclosed, but - on the contrary - the intention is to cover all modifications, equivalents, and alternative forms using the specific embodiments.

### DESCRIPTION

There is a general need for improved systems and methods that can effectively analyze traffic from both IT and OT networks to provide a more unified understanding of network assets and their behavior. Embodiments of the disclosure relate to a cyber security appliance for monitoring converged Information Technology (IT) and Operational Technology (OT) networks. The appliance comprises a processing component and a non-transitory computer readable medium, which in turn stores one or more software modules. These modules include, for example, an operational technology (OT) module configured to receive data from an OT network, and one or more machine-learning models trained on a normal pattern of life for a plurality of OT assets. A comparator module cooperates with these components to compare data received from the OT network to the normal pattern of life to detect anomalous activity.

As described herein, a feature of the embodiments are the addition of an asset identification module configured to provide human-readable context to the monitored OT assets. This module passively monitors the data from the OT network to identify one or more properties of the plurality of OT assets. These identified properties can include, for example, an observed communication protocol, an identified device type, a determined subnet, or a vendor derived from a MAC address. The asset identification module is configured to apply a priority-based rule set to these properties to generate a specific, human-readable label for each asset, which is then used by other modules.

Embodiments described herein further comprise an architecture generation module that is configured to create logical visualizations of the OT network. This module is configured to receive the human-readable labels for the plurality of OT assets from the asset identification module. After receiving the labeled assets, the architecture generation module applies a grouping to the plurality of OT assets to create one or more asset groupings. Finally, the module generates architecture visualization data that represents these asset groupings, which can then be sent to a user interface module for display.

The grouping applied by the architecture generation module is flexible and can be performed in multiple ways. In one embodiment, the grouping is automatic and configured to identify a shared characteristic among the plurality of OT assets. This shared characteristic can be based on the properties identified by the asset identification module, such as creating groupings based on a shared manufacturer, a shared device type, or a shared subnet. Alternatively, the grouping can be based on a user-defined filter applied to the plurality of OT assets, allowing an operator to create custom groupings based on their own operational logic.

Another aspect of these embodiments is the enhancement of the system's alerting capabilities, providing for operational health management in addition to cybersecurity. The comparator module is further configured to distinguish between anomalous activity indicative of a cyber threat and anomalous activity indicative of an operational health issue. For example, the comparator module can generate an operational health alert by detecting an absence of the expected communication from an asset, such as when a device goes offline unexpectedly. In another embodiment, the module generates an operational health alert by detecting that a device's current operational state is different from a stored operational state, such as changing from “run” to “stop”. These distinct alert types, both cyber threat alerts and operational health alerts, can then be presented to an operator on a unified dashboard on a common display screen.

Operational Technology (OT) systems, such as Industrial Control Systems (ICS), are computer networks used to monitor and control industrial systems. These systems are critical to major manufacturing and critical infrastructure. Example OT networks can include Industrial networks; Product Manufacturing (TVs, Cars, etc.); Food & Pharmaceuticals; Utilities (such as energy generation & distribution); Maritime & logistics; Industrial design; Oil & Gas, Building Management, Transport, among others.

ICS environments are most commonly a mixture of Personal Computing systems and specialized hardware such as Programmable Logic Controllers (PLCs), Human Machine Interfaces (HMIs), and other controllers. PLCs are often employed as a bridge between the network and the physical process and consequently, PLCs are connected to non-networking equipment such as pressure sensors or motors.

A primary challenge in this field is the convergence and blending of IT and OT environments. The OT environment is not restricted to OT-specific devices and protocols, and vice versa. Commonly, IT devices and services are located within OT environments for purposes such as cross-compatibility or specific control procedures. Equally, traditionally OT hardware may be located within an IT network, such as scientific equipment or specialized analysis devices. Devices may also move between OT and IT based upon their implementation purposes, such as an IT server running OT software or coordinating OT protocols.

This blending makes OT devices uniquely vulnerable. PLCs and other OT-specific devices are extremely vulnerable to cyber-attacks due to their architecture and their exposure to the IT zone, where traditional cyber threats are located. Cyber threats, misconfigurations, and malfunctions are incredibly costly to remediate in OT environments due to the large scale and complex nature of the network topology and associated devices.

OT networks have distinct architectures. An OT network typically includes IP and Ethernet-based areas, but may also use other transports. These networks rely on specialized, application-layer OT protocols (e.g., Modbus, DNP3, and CIP) to manage the detailed process control communications between entities. This architecture often includes IP gateways, which are devices that convert traffic from a TCP/IP network into an alternative media, such as the Serial Communication protocol, while also acting as a router. For example, a single gateway device with one IP address using Modbus/TCP may control a dozen downstream Serial (RS-485) lines carrying a serial-based protocol. To route data to the correct non-IP device, the application layer information within the TCP/IP network traffic must include the final destination address.

This complex architecture creates monitoring challenges. A monitoring system must be able to “see through” these end-point IP gateways to the older OT networks (e.g., Serial lines). A communications messaging detector must be configured to understand both OT-specific protocols and TCP/IP network communications to provide visibility into OT devices that are not directly attached to the TCP/IP network. The user interface must also be able to display OT network components such as controllers and PLCs that exist beyond an endpoint IT component.

Given the critical nature of these systems, monitoring must be non-disruptive. A monitoring appliance should be able to monitor an industrial network with no disruption to normal functioning of ICS operations, including plants and machinery, and avoid interfering with critical control communication unless explicitly permitted to perform an autonomous action. This enhanced visibility is advantageous even when a cyber threat is not detected, as malfunctions or misconfigurations in the production process can be viewed in the same manner. A monitoring system can highlight unusual connectivity or data transfer within the OT network, between the OT and IT network, and between the OT network and third-party locations such as the internet or networks administrated by suppliers.

Monitoring these blended environments requires specialized analysis. An OT module can reference one or more machine-learning models trained on a “normal pattern of life” of specific OT environment entities, such as PLCs, HMIs, and the detailed process control communications between them. This analysis is not limited by physical network boundaries; an OT module may still analyze the pattern of life for an OT device even if it is physically located in a computer lab within the IT network. These models can be trained on known OT risks, such as a new device appearing and interacting with OT systems; an engineering workstation performing OT reconnaissance scans; an OT application server beaconing to a rare internet destination; or an HMI infected with malware.

Finally, responding to threats in an OT environment requires a specialized approach. In OT networks, indirect autonomous response methods (such as sending a block command to a firewall) might be preferred over direct actions (which could disrupt a physical process). Therefore, an autonomous response module can use models trained specifically on OT activity to provide suggestions on allowed actions that can counter a threat without causing unacceptable effects in the industrial environment.

### Additional Details

The following text below discusses how some of the other components in the cyber security system operate; and thus, how these components respond to the commands, requests, and communications from the system.

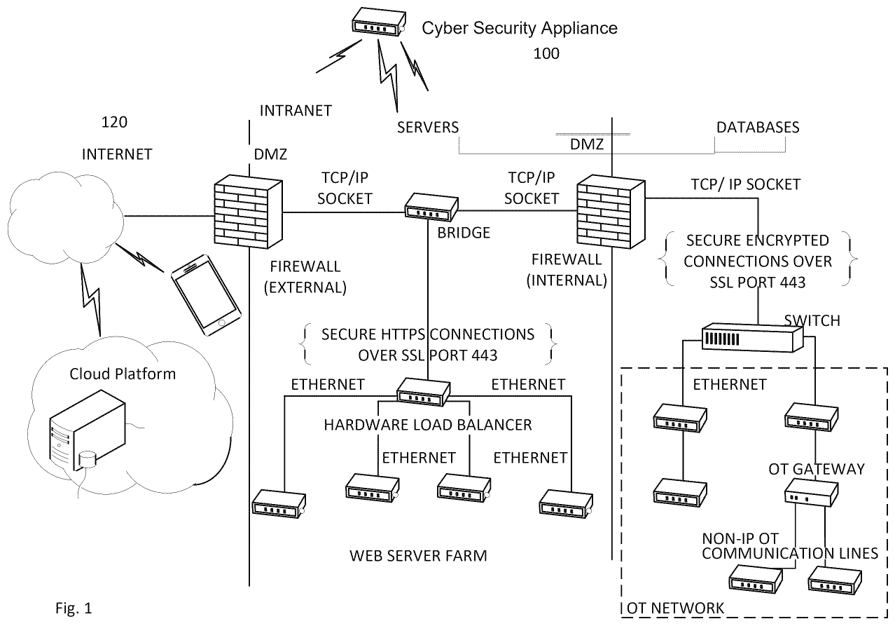

Referring to FIG. 1, a schematic diagram of a network environment which may include a cyber security appliance 100 is shown, in accordance with an embodiment of the disclosure. The network environment may represent a corporate or enterprise setting where a plurality of electronic communications are transmitted and received by various entities. In an embodiment, the environment may include components such as a cyber security appliance 100, a connection to the internet 120, a cloud platform, a firewalled intranet, various servers, a web server farm, and a database cluster. The various components may be communicatively coupled, allowing for the flow of data and communications throughout the organization and to external locations. This environment is exemplary, as it represents the Information Technology (IT) infrastructure that often connects to and provides a pathway to a separate, Operational Technology (OT) network.

In various embodiments, the cyber security appliance 100 is configured to monitor, analyze, and take action on electronic communications to protect the entire converged (IT/OT) network environment from threats. The cyber security appliance 100 may be implemented as a physical appliance, a virtual appliance, or as a cloud-based service that is communicatively coupled to the network. As depicted in the embodiment shown in FIG. 1, the cyber security appliance 100 may be positioned to observe traffic within the intranet, including communications originating from or directed to the servers, databases, and other infrastructure. The cyber security appliance 100 is configured to perform various analyses as described herein, such as passive network monitoring, parsing of specialized industrial protocols, asset identification, and pattern of life modeling, to identify anomalous communications that deviate from an established pattern of normal behavior for both IT and OT assets.

In certain embodiments, the cyber security appliance 100 may build and maintain a dynamic, ever-changing model of the ‘normal behavior’ or ‘pattern of life’ for each user and device within the system. This approach may be based on unsupervised machine learning and can involve monitoring a wide array of interactions, events, and communications. For this application, this monitoring through an OT gateway is extended to the specialized devices in an OT network, such as Programmable Logic Controllers (PLCs). By establishing a bespoke ‘pattern of life’ for each entity (both IT and OT), the cyber security appliance 100 can spot behavior that falls outside of this normal pattern, such as a new connection from an IT server to a PLC, and flag this behavior as anomalous, which may indicate a cyber threat or an operational health failure.

The servers shown in FIG. 1 may represent the various traditional IT assets, such as engineering workstations or human-machine interface (HMI) controllers, used by individuals within the organization to conduct their daily tasks. These devices may serve as the primary origination point for outbound communications to the OT network (e.g., sending new instructions to a PLC) and the final destination for inbound data from industrial sensors. In certain embodiments, an operator may use one of these servers to initiate a workflow, such as acknowledging an operational health alert or reviewing the asset properties of a newly discovered PLC. The behavior of these servers, including the applications used (e.g., engineering software), the industrial devices they connect to, and the protocols they use, may also be monitored as part of establishing a normal pattern of life.

The network environment may further include connectivity to external resources via the internet 120. The internet 120 may serve as the primary conduit for communications entering and leaving the organization's private network, including potential cyber threats or legitimate remote access sessions from third-party vendors who need to maintain industrial equipment. The cyber security appliance 100 may be configured to monitor traffic flowing to and from the internet 120 to detect threats such as command-and-control communications or attempts to infiltrate the IT network as a first step toward accessing the more sensitive OT network. The analysis of communications may involve examining the reputation of external domains, the structure of packets, and other characteristics of traffic passing through the network's perimeter.

In an embodiment, the network may include access to a cloud platform. The cloud platform may host a wide range of services, applications, and data storage used by the organization, including data lakes for historical industrial process data or cloud-hosted management controllers for modern OT equipment. The cyber security appliance 100 may be configured to extend its monitoring and protection capabilities to the cloud platform, analyzing API calls, data transfers, and user activities within the cloud environment. This ensures a consistent security posture across both on-premises resources (like the web server farm) and cloud-based resources, both of which could be used as vectors to attack the OT environment.

The IT network of FIG. 1 connects to an Operational Technology (OT) network. This OT network comprises the industrial control systems, such as the aforementioned PLCs, sensors, actuators, and other machinery critical to a physical process. The cyber security appliance 100 is configured to monitor this OT environment by passively ingesting network traffic, often via probes or sensors connected to network switches within the industrial zone. This passive approach is critical in OT environments, as active scanning (common in IT) can disrupt or damage sensitive industrial devices. This monitoring allows the appliance to analyze the specialized industrial protocols, such as Modbus, CIP, or BACnet, that are used for communication between these OT devices.

A useful function of the cyber security appliance 100 is monitoring the IT/OT convergence. This convergence represents the critical boundary where data flows between the IT network shown in FIG. 1 and the industrial OT network. The protection of this boundary is increasingly important as it is a primary target for malicious actors seeking to cause physical disruption. In an embodiment, the cyber security appliance 100 is configured to apply specific pattern of life models to these convergence pathways, applying enhanced scrutiny to any communication originating from the (typically less secure) IT side and attempting to communicate with a sensitive (and typically unsecured) OT asset.

As part of its analysis, the cyber security appliance 100 may be configured to perform asset identification and labeling. In an embodiment, this process may represent a deterministic, rules-based system where monitored traffic from the OT network is parsed to extract key identifiers. For example, a MAC address can be used to query an internal database to identify the asset's vendor, while other packet details can reveal the device type or protocols used. This configuration may allow the cyber security appliance 100 to automatically apply human-readable labels to assets (e.g., “Siemens S7 PLC” or “Rockwell HMI”), which are then presented in a user interface, thereby providing clear and understandable context to an operator.

The internal network may be segmented for security purposes, for example, by using a first firewall (external) and a second firewall (internal) to create one or more demilitarized zones (DMZ). These firewalls may be configured to inspect and filter traffic based on a set of security rules, controlling access between the internet 120, the DMZ, and the trusted intranet. In a converged environment, this DMZ is often where specific IT and OT systems are permitted to communicate, such as an IT-based historian server pulling data from an OT-based PLC. The cyber security appliance 100 can apply specific monitoring policies to traffic traversing these TCP/IP sockets in the DMZ. In certain embodiments, a network bridge may be used to connect different network segments, and a hardware load balancer may be used to distribute traffic efficiently across multiple servers, such as those in a web server farm.

The internal network may also contain various other infrastructure components such as a web server farm, which may host the organization's public-facing websites, and a database cluster, which may store critical business or operational data. The cyber security appliance 100 may be configured to monitor the interactions between all of these components, understanding the normal patterns of communication between them. For example, it may learn that a particular web server normally communicates with a specific database server using SQL. The appliance could then flag a connection attempt from that same web server to a critical PLC on the OT network (using a protocol like Modbus) as a highly anomalous and high-risk event, as this behavior is a strong deviation from its normal pattern of life. These communications may be facilitated by a network switch, which directs traffic between devices on the same local area network using high-speed ethernet connections.

The cyber security appliance 100 may protect the Operational Technology network using at least a three-stage project to improve the visualization, modelling, analysis, and workflow for interacting with OT devices in the threat visualizer user interface. The cyber security appliance 100 may monitor and report an operational status of OT devices, while still monitoring, detecting, and responding to cyber threat-focused alerts.

The cyber security appliance 100 may improve the visualization and display of OT devices. On the Threat Visualizer user interface associated with the cyber security appliance 100, OT devices will now be labelled with placeholders that make it easier for operators to recognize their purpose.

The cyber security appliance 100 may better the asset management and operational alerting. The cyber security appliance 100 may provide operational alerts alerts about the health of IT/OT components within the wider network. These alerts are not threat-focused and tend to be more about outages or failures or unexpected changes. The cyber security appliance 100 supplies alerts on both alerts to the cyber security team about unusual activity that could be a cyber security threat as well as alerts on outages, failures, and/or unexpected changes. The AI models and AI classifiers in the cyber security appliance 100 are very good at detecting the emergence of new activity, but may not look for the absence of previously occurring events. In operational management, knowing that something is no longer operating how it did previously is very valuable. The asset identification module and comparator module in the cyber security appliance 100 can cooperate with the one or more machine-learning models trained on the normal pattern of life to detect the absence of expected behaviour (e.g., a device no longer sending a specific type of traffic, indicating it is likely non-functional or down in some way) must be developed. The cyber security appliance 100 uses the machine-learning models trained on a normal pattern of life of users, devices, and/or controllers of the OT network in the cyber security appliance with various modules including an OT module and an IT module.

The user interface module in the cyber security appliance 100 can use alerts that are defined. The user interface module works with the comparator module to send the alerts.

The architecture generation module works with the asset identification module to perform asset management on components within the OT network. The architecture generation module can automatically generate architecture diagrams and assist in their display. OT assets will be grouped automatically using a similar methodology and visualization tool. The architecture generation module connects specific OT assets using rules based upon the nature of the assets themselves and the types of systems present in OT environments. Example connections or groupings may be based on same protocol use (e.g., your BACNET system), or on a shared vendor (e.g., your SIEMENS infrastructure). These are not exhaustive examples, and more heuristic connections will also be made. The architecture generation module will prioritize and display OT architectures that can be high-risk assets or assets with alerts. The architecture generation module has an input to allow customization/personalization/creation of new architectures to also be possible. The architecture generation module assigns ownership of each architecture to align with wider business goals of adding ownership/contact information into the platform.

The cyber security appliance 100, by observing the entire network environment, can correlate events across different domains. For example, it might detect an anomalous connection from the internet 120 to a server in the web server farm. Shortly thereafter, it might observe that same server attempting to open a new connection using a specialized OT protocol (like Modbus or CIP) to a critical PLC on the OT network. By correlating these two low-level events, the system can identify a high-risk IT/OT convergence attack that might otherwise be missed if each event were viewed in isolation. This correlation is non-trivial as it requires the appliance to understand the “normal” behavior of both IT and OT assets and their typical interactions.

The overall architecture depicted in FIG. 1 provides a comprehensive view of a modern enterprise's IT network. The placement and configuration of the cyber security appliance 100 within this environment allows it to have broad visibility into a wide range of communication channels and user activities, as well as into the connected OT environment. This visibility is useful to the system's ability to build accurate ‘pattern of life’ models for all assets. This, in turn, allows the system to detect the subtle deviations that may indicate a sophisticated cyber threat, or equally important, an internal operational failure.

In an embodiment, the cyber security appliance 100 may use unsupervised machine learning to continuously learn and adapt its understanding of what constitutes normal behavior. This self-learning capability allows the system to remain effective even as the organization's environment changes, such as when new industrial devices are added to the OT network or when communication patterns shift due to new operational demands. The system can learn “on the job” from the real-world data it observes, constantly refining its models to become more bespoke and accurate over time, which is a significant advantage over static, signature-based security tools.

The system may also be configured to take a variety of autonomous response actions when an anomaly is detected. These actions may be surgical and proportionate to the detected event, aiming to neutralize a threat while minimizing disruption to critical business or industrial processes. For example, upon detecting a critical PLC has stopped communicating in a manner that deviates from its normal pattern of life (e.g., it is not a scheduled maintenance window), the system may generate a specific “operational health alert”. This alert can be sent directly to an OT engineer, rather than generating a cyber threat alert for the IT security team, ensuring the right information gets to the right person to investigate the potential physical failure.

In various embodiments, the network environment shown in FIG. 1, therefore, can serve as the operational domain for a sophisticated, AI-driven security platform. The platform can be configured to protect against a wide range of threats by understanding the unique ‘pattern of life’ of the organization. This protection is achieved by detecting subtle deviations from that norm across multiple vectors, including traditional IT traffic, cloud services, and critical IT-to-OT communications. The system unifies cybersecurity threat detection with operational health monitoring, providing a single, comprehensive view of the entire converged network.

The methods and systems shown in the Figures and discussed in the text herein can be coded to be performed, at least in part, by one or more processing components with any portions of software stored in an executable format on a computer readable medium. Thus, any portions of the method, apparatus and system implemented as software can be stored in one or more non-transitory machine-readable storage devices in an executable format to be executed by one or more processors. The computer-readable storage medium may be non-transitory and does not include radio or other carrier waves. The computer readable storage medium could be, for example, a physical computer readable storage medium such as semiconductor memory or solid-state memory, magnetic tape, a removable computer diskette, a random-access memory (RAM), a read-only memory (ROM), a rigid magnetic disc, and an optical disk, such as a CD-ROM, CD-R/W or DVD.

A computing system can be, wholly or partially, part of one or more of the servers or the cyber security appliance 100 in accordance with an embodiment. Components of the computing system can include, but are not limited to, a processing unit having one or more processing cores, a system memory, and a system bus that couples various system components including the system memory to the processing unit. The processing unit may be configured to execute computer-readable instructions to perform the various analyses described herein, such as monitoring network traffic, building pattern of life models, and generating alerts.

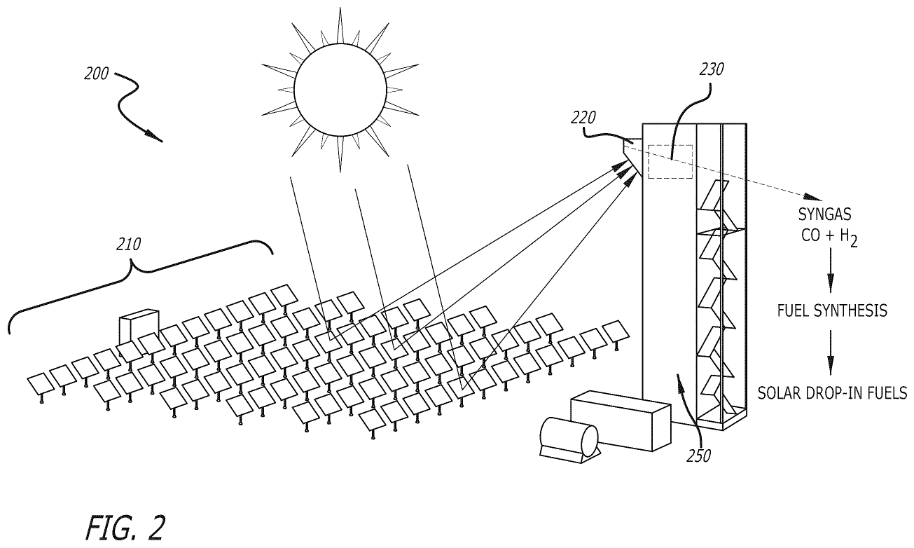

Although a specific embodiment for the network environment is described above with respect to FIG. 1, any of a variety of systems and/or processes may be utilized in accordance with embodiments of the disclosure. For example, the cyber security appliance 100 may be implemented as a distributed software solution running on existing servers within the network environment rather than as a dedicated physical or virtual appliance. Additionally, the networking environment may include a different number of devices and connections and those skilled in the art will recognize that this layout is exemplary and not instructional. The elements depicted in FIG. 1 may also be interchangeable with other elements of FIG. 2-17 as required to realize a particularly desired embodiment.

Referring to FIG. 2, a diagram of an exemplary industrial environment 200 is shown, in accordance with an embodiment of the disclosure. The depicted industrial environment 200 is a solar fuel production facility, which serves as a detailed example of a complex, converged Information Technology (IT) and Operational Technology (OT) network. Such an environment is monitored by the cyber security appliance 100 described herein. The industrial environment 200 may include components such as a heliostat field 210, a central solar receiver 220, and a fuel synthesis facility 230, which contains a reactor and other processing equipment. This industrial environment relies on a combination of traditional IT assets (like servers and workstations) for management and data collection, as well as a large-scale, specialized OT network (comprising PLCs, actuators, and sensors) to control the physical processes.

In various embodiments, the heliostat field 210 represents a large-scale OT network in itself. This heliostat field 210 may consist of thousands of individual sun-tracking mirrors, each requiring precise, real-time adjustments to focus solar energy onto the receiver 220. This precise physical control may be managed by numerous distributed Programmable Logic Controllers (PLCs), actuators, and positioning sensors. These devices form a classic OT network, communicating over specialized industrial protocols. The cyber security appliance (100) may be configured to passively monitor this control network, learning the pattern of life of these devices. This pattern of life would include, for example, the specific timing of tracking commands sent to the actuators based on the time of day and the sun's position, as well as the expected cadence of feedback from the positioning sensors that confirm the mirrors are aligned. The system can then perform asset identification to label them in a user interface (e.g., “Heliostat Control PLC-Sector 4”).

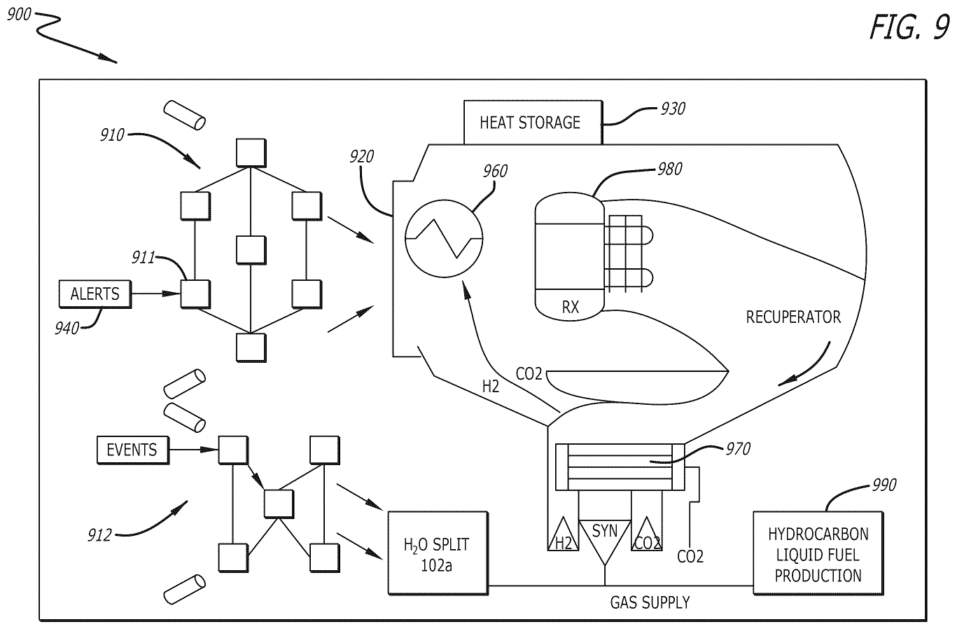

The core industrial process occurs at the solar receiver 220 and within the fuel synthesis facility 230, both of which may be located on a central solar tower 250. As indicated in the diagram, concentrated solar energy from the receiver 220 is used to drive a thermochemical process, converting syngas (a mixture of CO and H2) via fuel synthesis into storable, solar drop-in fuels. This synthesis process involves the precise management of numerous physical assets and chemical flows. As shown schematically in FIG. 9, this can include a variety of OT components such as a primary reactor, a heat exchanger, a heat storage unit, and gas supply units, all of which are managed to create a final hydrocarbon liquid fuel production. The cyber security appliance 100 is configured to monitor each of these as distinct OT assets. For example, the appliance 100 would monitor the reactor not as a single object, but as a system of interconnected sensors and actuators. It would learn the complex pattern of life of this system, such as the normal relationship between its temperature sensors, pressure sensors, and the PLCs controlling its outflow valves. An operational health alert could be triggered if a pressure sensor reports a value that deviates from the learned model (e.g., pressure rising before temperature, indicating a blockage), even if the sensor itself has not technically “failed.”

In further embodiments, the monitoring extends to all related sub-systems. The heat exchanger and heat storage unit are also monitored as critical OT assets. The pattern of life for the heat exchanger would involve modeling the relationship between the inlet and outlet temperatures on both of its circuits. A deviation, such as the outlet temperature on the secondary loop failing to rise when the primary loop inlet temperature is high, could signify an internal failure or inefficiency, allowing the system to trigger an operational health alert for maintenance before it causes a full-scale production halt. Likewise, the gas supply can be monitored by learning the normal operational commands sent to its control valves and flow meters. Any attempt to command these valves to open outside of a scheduled production run, especially from an IT-based workstation, would be flagged as a clear, high-risk anomaly. This critical process may be managed by another set of OT assets, including primary control PLCs, safety-instrumented systems (SIS), and specialized sensors. The cyber security appliance 100 may monitor all these critical OT assets not only for cyber threats but for operational health. For example, if a critical temperature sensor in the facility 230 that is expected to send a signal every five seconds suddenly stops communicating, the appliance 100 can detect this “absence of expected behavior” and generate a specific “operational health alert” to notify an OT engineer of a potential equipment failure.

In many embodiments, while the heliostat field 210 and synthesis facility 230 are controlled by the OT network, the entire industrial environment 200 is managed using a traditional IT network. This IT network may include engineering workstations, Human-Machine Interface (HMI) servers, and various databases. These IT assets are used by human operators and site administrators to visualize the industrial environment's status (as suggested in various figures herein), review production yields, and store historical operational data. These IT servers, which act as the “window” for the site administrator, can communicate with the underlying OT devices to retrieve this data, receiving the alerts and events generated by the control system. The cyber security appliance 100 learns that an HMI pulls data (a read-only operation) from a wide array of PLCs, while a historian database only receives data from those PLCs and never initiates a connection to them. This flow of information from the PLCs in the facility 230 to the various databases on the IT network is a primary example of IT/OT convergence.

The cyber security appliance 100 may be configured to monitor this IT/OT convergence boundary with enhanced scrutiny. For example, the appliance 100 may learn the pattern of life of an HMI server, noting that it normally reads data from the PLCs in the heliostat field 210 every 30 seconds but never writes new control logic to them. If an attacker were to compromise the IT network and use that HMI server to send a new, anomalous command to the heliostat PLCs (e.g., a “write” command to point them away from the receiver 220 and disrupt production), the cyber security appliance 100 would detect this as a significant deviation from the established “pattern of life.” This event may be correlated with other data and flagged as a high-risk cyber threat. This anomalous command is detected not just because it came from an HMI, but because the command itself (e.g., “point away from receiver”) is a deviation from the learned set of normal operational commands, allowing the system to generate an alert or take an autonomous response action to block the malicious communication before physical disruption occurs.

In various embodiments, the industrial environment 200 shown in FIG. 2, therefore, serves as a detailed example of a complex, converged IT/OT environment. It illustrates how a centralized cyber security system (100) can be configured to provide unified monitoring across the entire operation. The system can provide this unified view by passively monitoring both IT and OT network traffic, automatically identifying and labeling all assets using their unique communication properties, and applying pattern of life models to detect both cybersecurity threats (like anomalous IT-to-OT commands) and operational health failures (like a non-responsive sensor in the synthesis facility 230 or an anomalous pressure reading in the reactor).

Although a specific embodiment for an exemplary industrial environment 200 for carrying out the various steps, processes, methods, and operations described herein is discussed with respect to FIG. 2, any of a variety of systems and/or devices may be utilized in accordance with embodiments of the disclosure. For example, while a solar fuel production facility is shown, the monitoring and analysis techniques described may be applied to any industrial environment, such as a chemical processing plant, an automotive manufacturing line, a maritime shipping vessel's control system, or the like. The elements depicted in FIG. 2 may also be interchangeable with other elements of FIG. 1 and FIG. 3-17 as required to realize a particularly desired embodiment.

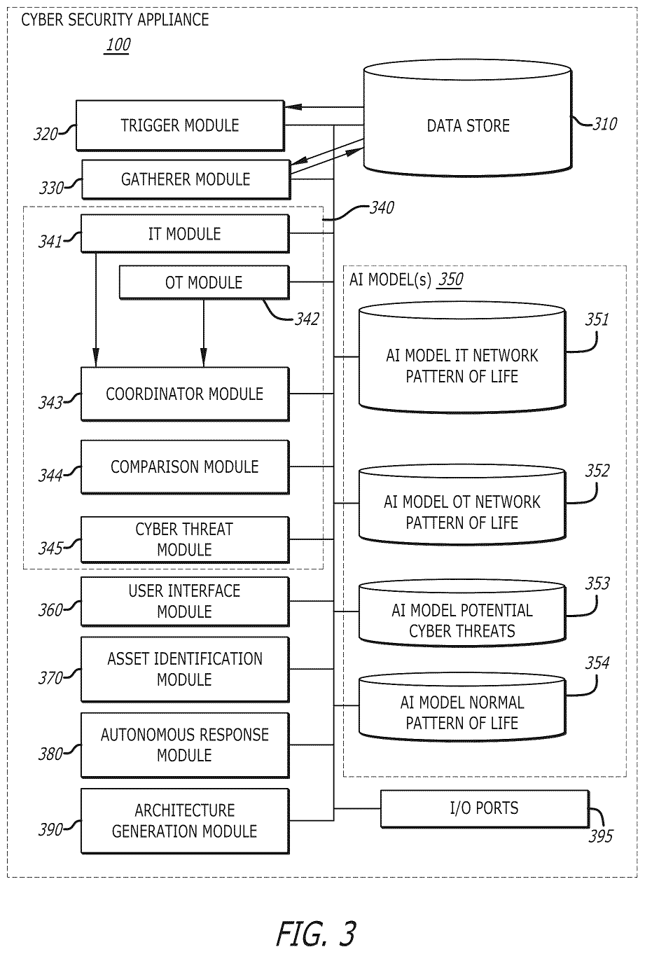

Referring to FIG. 3, a block diagram of an embodiment of an AI-based cyber security appliance 100 with example components is shown, in accordance with various embodiments of the disclosure. Various artificial intelligence models and modules of the cyber security appliance 100 may cooperate to protect a system, such as one or more converged IT and OT networks or domains under analysis, from cyber threats and operational failures. In an embodiment, the AI-based cyber security appliance 100 may include components such as a trigger module 320, a gatherer module 330, an IT module 341, an OT module 342, a coordinator module 343, a comparison module 344, a cyber threat module 345, a user interface module 360, an asset identification module 370, an autonomous response module 380, an architecture generation module 390, a data store 310, one or more AI model(s) 350, and one or more I/O ports 395.

The cyber security appliance 100 can host a detection engine and other components configured to protect a network or other digital environment, such as the converged IT/OT environments. The cyber security appliance 100 may include a set of modules cooperating with one or more artificial intelligence models configured to perform a machine-learned task of detecting a cyber threat incident or an operational health anomaly. In certain embodiments, the detection engine may use the set of modules cooperating with the one or more artificial intelligence models 350 in the cyber security appliance 100 to prevent a cyber threat from compromising one or more nodes, such as IT servers or OT controllers, and/or from spreading through the nodes of the network being protected by the cyber security appliance 100. This protection may extend to both traditional IT assets (e.g., databases, workstations) and critical OT assets (such as PLCs, sensors, or actuators), by applying the analytical methods described herein to the communications and activities within the monitored environment.

The cyber security appliance 100 represents a significant architectural evolution by merging previously separate functionalities into a single, unified appliance. Prior art systems, including previous versions, often required two distinct physical boxes: one appliance dedicated to the IT network and a separate appliance for the OT network. The present disclosure, by contrast, integrates both the IT module 341 and the OT module 342 into a single chassis. This unified “one-box” solution allows the coordinator module 343 to perform much tighter, real-time correlation between the IT and OT domains, as all data is processed within the same appliance.

In an embodiment, a trigger module 320 may be configured to initiate an investigation or analysis process. The trigger module 320 may be activated in response to a specific event, a detected anomaly, or an alert generated by another component within the cyber security appliance 100. For example, a model breach from the AI Model OT Network Pattern of Life 352, indicating a deviation from a normal, cyclical pattern of life for a monitored industrial asset, may serve as an input to the trigger module 320. The trigger module 320 may function as the initial “nervous system” response of the appliance, recognizing that an event warrants further scrutiny beyond standard, passive monitoring.

The trigger module 320 may receive inputs from various sources, such as the IT module 341 or the OT module 342, when a communication or device behavior exhibits unusual characteristics. In certain embodiments, an alert from the AI Model OT Network Pattern of Life 352, such as detecting the “absence of expected behavior” from a critical PLC, could activate the trigger module 320. This trigger may also be activated by the comparison module 344 detecting a high-risk IT/OT convergence event that violates a known policy. This hand-off process ensures that analytical resources are allocated efficiently, focusing deeper investigations on events that have already met a preliminary threshold of suspicion. The cyber security appliance 100, using the cyber threat module 345, can then launch a full, in-depth investigation on these triggered events.

A gatherer module 330 may be configured to collect data from various internal and external sources to support the analytical functions of the cyber security appliance 100. The gatherer module 330 may be configured with one or more classifiers, such as a protocol identifier classifier or a vendor classifier, to identify and track processes, devices, and communication connections within the IT and OT networks under analysis. In an embodiment, the gatherer module 330 may retrieve historical data from the data store 310 or collect real-time data from network sensors, such as network taps or span ports, that are monitoring both enterprise traffic and industrial control system traffic. The data collected can include a wide range of information, such as packet headers, protocol-specific metadata, and even full packet content, depending on the system's configuration.

The gatherer module 330 may work in close cooperation with the domain-specific modules, the IT module 341 and the OT module 342. For example, to support the OT module 342, the gatherer module 330 may be tasked with collecting all traffic that uses specialized industrial protocols (e.g., Modbus, CIP, BACnet, or S7). Similarly, to support the asset identification module 370, the gatherer module 330 may be configured to retrieve all packet headers containing MAC addresses, parse vendor-specific identifiers from OT traffic, or extract device type information. This close cooperation ensures that the various analysis modules receive a complete and context-rich dataset, which is useful for accurate and reliable threat and operational health detection.

A data store 310 may serve as a centralized repository for storing a wide range of information used by the cyber security appliance 100. This may include historical logs of network traffic, industrial process communications, device activity, inter-device connection logs, and other events. In an embodiment, the data store 310 may also house the various AI model(s) 350, including the AI Model IT Network Pattern of Life 351, the AI Model OT Network Pattern of Life 352, the AI Model Potential Cyber Threats 353, and the AI Model Normal Pattern of Life 354. This centralized storage facilitates efficient data retrieval and cross-domain correlation, allowing the system to link an event in the IT domain (like a new workstation login) to a subsequent event in the OT domain (like a new PLC command).

The data store 310 may be configured to maintain data over a specific retention period, allowing the cyber threat module 345 to conduct long-term investigations and trend analysis. The historical data stored within the data store 310 is useful to the system's ability to establish a normal ‘pattern of life’ for each entity. For example, the cyclical pattern of life for a specific PLC, which is utilized by the AI Model OT Network Pattern of Life 352, may be built and continuously updated using the communications data maintained in the data store 310. This continuous updating process ensures that the ‘pattern of life’ models remain accurate and can adapt to the natural evolution of system behavior and operational schedules over time.

In various embodiments, an IT module 341 may be configured to interface with and analyze communications and data from the traditional Information Technology network. The IT module 341 may be configured with algorithms and components to understand IT-specific parameters, protocols, and formats (e.g., HTTPS, SMB, RPC). It may receive data from the gatherer module 330 related to standard enterprise devices like servers, workstations, firewalls, and databases. This module may act as the primary ingestion and analysis point for all IT-related data before it is passed to the coordinator module 343 or used to query the AI Model IT Network Pattern of Life 351 for anomalies.

As depicted in the embodiment shown in FIG. 3, the IT module 341 operates in parallel to the OT module 342. The IT module 341 is responsible for modeling the behavior of assets within the enterprise zone, identifying threats such as malware-infected workstations or compromised servers. This is a critical function, as these compromised IT assets are often the staging ground for attacks that later pivot into the operational environment. The IT module 341 passes its findings, such as a newly compromised workstation, to the coordinator module 343 for correlation against OT network activity.

In a similar manner, an OT module 342 may be configured to interface with and analyze communications and data from the Operational Technology network. The OT module 342 is specialized for industrial environments and is configured to parse and understand specialized OT protocols, such as Modbus, CIP, BACnet, or S7. This module is responsible for processing data from assets like PLCs, sensors, actuators, HMIs, and distributed control systems (DCS). The analytical output from the OT module 342 is then routed to the coordinator module 343 and used to query the AI Model OT Network Pattern of Life 352.

The OT module 342 is specifically designed to understand the cyclical and deterministic nature of industrial communications. Unlike the IT module 341, which models the more variable behavior of human users and servers, the OT module 342 models the highly predictable, machine-to-machine pattern of life of industrial processes. This specialization allows it to detect very subtle anomalies, such as an “absence of expected behavior” when a sensor fails to report, or the presence of an unexpected but valid-looking command, which could indicate a sophisticated attack.

An asset identification module 370 may be configured to perform the core analysis of identifying and labeling devices across the converged network. The asset identification module 370 may apply a deterministic, rules-based process to data provided by the gatherer module 330. For example, it may extract a MAC address to query an internal database for a vendor, parse industrial protocol traffic to identify a device type (e.g., “Siemens S7 PLC”), and analyze communication patterns to infer the asset's purpose (e.g., “Heliostat Controller” or “Reactor Temperature Sensor”). One advantage of this approach is its ability to provide human-readable labels and context to OT engineers who may not recognize devices by IP address alone.

The asset identification module 370 may interact closely with the data store 310 to retrieve known asset properties and with the gatherer module 330 for new device data. Once an asset is identified and labeled, this information may be passed to the user interface module 360 for display in an asset inventory. This identification data also serves as a critical input for the architecture generation module 390, which uses the asset labels and properties to create logical groupings and visualizations. This module may also be configured to identify “virtual assets,” such as non-IP serial devices that are communicating through an IP gateway, by parsing the packet payloads to extract sub-device addresses.

While the system's primary method of data collection is passive monitoring, it can be optionally augmented with an “Active ID module”. This optional component is not passive and can reach out to operational technology devices and ask them to identify themselves. This “promiscuous mode” can be used by a customer to gather additional contextual data to better deduce the purpose of certain devices. This active data, when available, is then combined with the passively collected data to provide a richer source for the asset identification module 370.

An architecture generation module 390 may be configured to automatically create diagrams and groupings of OT assets. This module is configured to generate these visualizations dynamically based on live network data, rather than relying on static, user-uploaded configuration files. The module can automatically cluster assets based on shared criteria, such as all devices from the same vendor (e.g., “All Siemens Devices”), all devices on the same subnet, or all devices using the same industrial protocol (e.g., “BACnet System”). This provides an immediate, high-level, and accurate view of the network's structure as it actually operates.

The output of the architecture generation module 390 may be used to create a more comprehensive risk assessment of the environment. For example, the module 390 allows a user to create arbitrary, custom groupings of assets they wish to monitor, such as a “Critical Production Line” group or “Safety-Instrumented Systems” group. The system can then use this grouping as a meta-layer, applying special monitoring rules or increasing the alert priority for any device within that group. This provides a multi-faceted view of risk that is flexible and tailored to the operator's specific operational needs, which is a significant improvement over rigid, static representations.

A coordinator module 343 may be configured to correlate information from the various domain modules, namely the IT module 341 and the OT module 342. It may work with various machine learning algorithms and relational mechanisms to assess and annotate activity occurring across the IT/OT boundary. This module is essential for understanding the converged environment, as it can link an event from an IT workstation to a subsequent command sent to an OT device, providing a unified view of a single incident.

This coordination is crucial for detecting sophisticated cyber threats. For example, the coordinator module 343 may receive data from the IT module 341 showing a workstation connecting to a known malicious command-and-control IP address. Moments later, it may receive data from the OT module 342 showing the same workstation initiating an anomalous connection to a previously unknown PLC on the factory floor. The cyber threat module 345, receiving this correlated data from the coordinator module 343, can identify this as a high-risk, multi-stage attack campaign, where an IT-based compromise is attempting to pivot into the OT network.

The comparison module 344 and cyber threat module 345 are also configured to identify operational health alerts, which are distinct from cyber threats. For instance, the OT module 342 may report that a critical temperature sensor has stopped sending its cyclical data transmission. The comparison module 344 compares this to the AI Model OT Network Pattern of Life 352 and identifies this “absence of expected behavior”. Because the coordinator module 343 reports that this event is not correlated with any malicious IT activity or other threat indicators, the cyber threat module 345 can classify it as a pure “Operational Health Alert”. This allows an OT engineer to be notified to investigate the equipment failure without triggering a false cybersecurity incident for the IT security team.

A comparison module 344 may be configured to perform rapid, first-level analysis of events to confirm the presence of a cyber threat or anomaly. It may be designed to identify overt and obvious issues that require an immediate response, often based on high-confidence indicators. For cyber threats, this could include matches to known threat intelligence from the AI Model Potential Cyber Threats 353. For operational health, this could include the “absence of expected behavior” or the detection of a known error state from an industrial device.

The comparison module 344 may receive inputs from the coordinator module 343 and can cooperate with the AI model(s) 350 to confirm a threat or failure. For example, if the asset identification module 370 identifies a new, unknown device on a critical OT subnet, the comparison module 344 could immediately flag this as a high-priority event. This rapid comparison capability can be utilized for containing fast-moving threats or for immediately alerting operators to sudden, critical equipment failures, where immediate action is critical.

A cyber threat module 345 may be configured to conduct longer-term and more in-depth investigations of potential and emerging cyber threats and operational anomalies. This module may focus on subtle, low-level anomalies that, in isolation, may not seem malicious or critical but could be part of a larger attack campaign or a cascading operational failure. This module may be configured to operate on a two-level basis, where the comparison module 344 handles the first level of overt detection, while the cyber threat module 345 handles a second level of investigation for more subtle, advanced persistent threats or slowly degrading equipment.

The cyber threat module 345 may be the primary consumer of the probabilistic scores generated by the AI Models (351, 352). It may use these scores as data points to form and investigate various threat hypotheses. The cyber threat module 345 may cooperate with the AI model(s) 350 trained on how to conduct investigations to test these hypotheses against the available data, building a chain of evidence over time. This deep investigative capability is what may allow the system to uncover advanced persistent threats (APTs) that are designed to remain hidden for long periods.

A user interface module 360 may be configured to present data, alerts, and analytical results to a human operator in a clear and understandable format. It is configured to generate the “Operational Overview” interface, which is a purpose-built dashboard for OT environments. This UI provides a “single or unified view that centralizes asset management, health monitoring, and risk insights, and is specifically tailored to the persona of an OT engineer or site administrator, who may not be a cybersecurity expert.

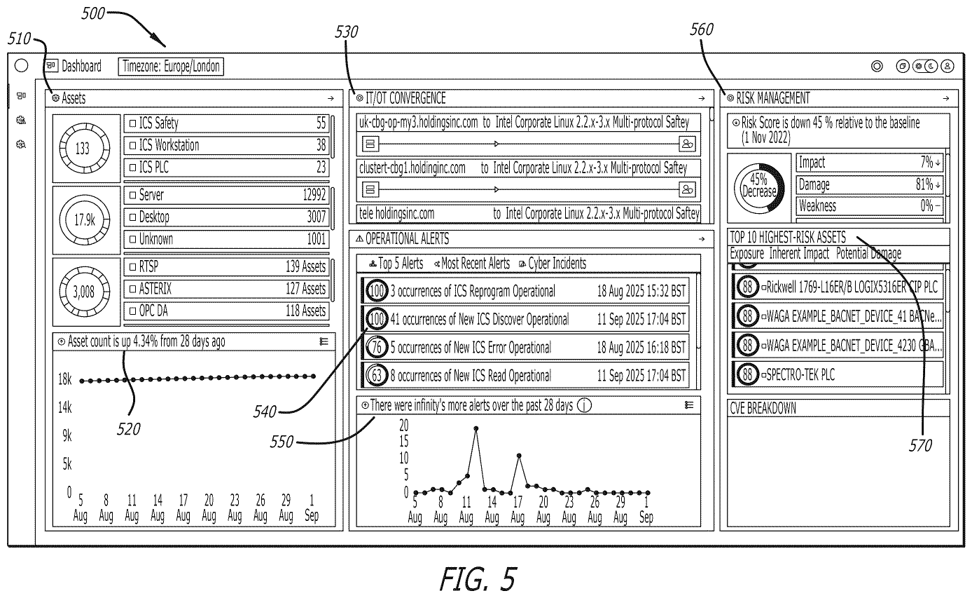

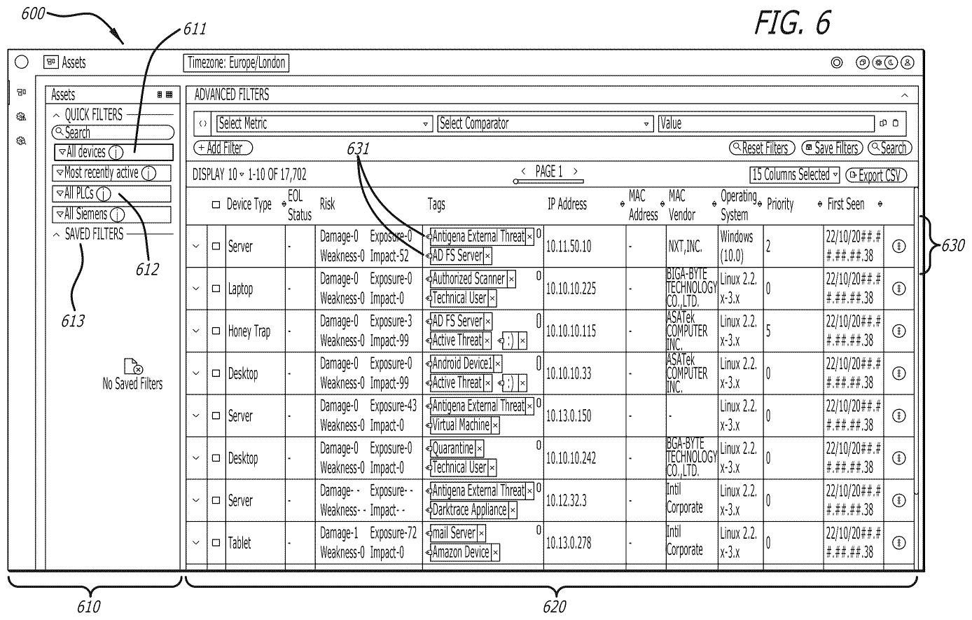

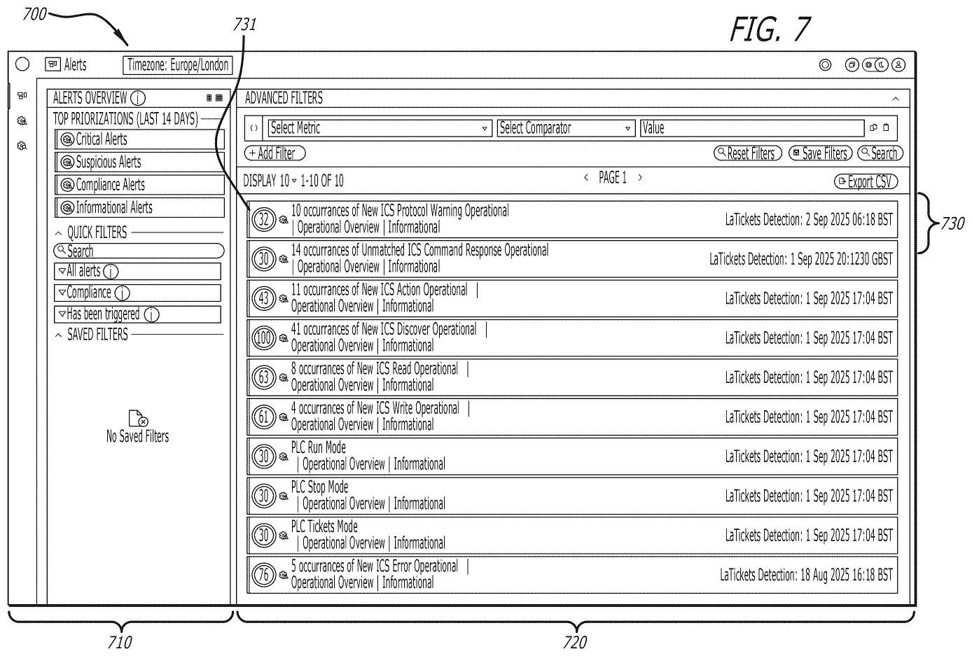

This module may be responsible for displaying the user interface screens shown in FIG. 5, FIG. 6, and FIG. 7. The user interface module 360 populates these views with data such as the output of the architecture generation module 390 and the labeled devices from the asset identification module 370. The user interface module 360 also presents the distinct “Operational Health” alerts generated by the cyber threat module 345, allowing an operator to see, for example, a “Device Offline” alert in a dedicated alerts tray.

An autonomous response module 380 may be configured to take one or more automated mitigation actions to neutralize detected threats. The actions taken may be proportionate to the threat and can be configured to minimize disruption to normal business or industrial operations. In an embodiment, this module may use one or more Application Programming Interfaces (APIs) to translate desired mitigation actions into a specific language and syntax utilized by other devices or software from various vendors, such as a firewall or network switch.

The autonomous response module 380 may be particularly valuable in responding to IT/OT convergence threats. For example, upon the cyber threat module 345 confirming a high-risk threat (e.g., an IT workstation attempting to write new logic to a PLC), the autonomous response module 380 could take a surgical action. Instead of shutting down the entire PLC (which could halt a physical process), it could send a command to a network firewall to specifically block only the anomalous connection from that IT workstation, thereby neutralizing the threat while allowing the critical OT process to continue operating without disruption.

The cyber security appliance 100 may utilize a suite of one or more AI model(s) 350 to perform its various analytical tasks. These models may be trained on different types of data and for different purposes, such as modeling normal behavior, identifying potential threats, and conducting investigations. This suite of models may work together as an ensemble, with the outputs of one model often serving as inputs to another, creating a sophisticated and multi-layered analytical process.

As depicted in the embodiment in FIG. 3, these can include distinct models for different network domains. An AI Model IT Network Pattern of Life 351 is trained on the behavior of enterprise devices, while a separate AI Model OT Network Pattern of Life 352 is trained on the unique, cyclical behavior of industrial assets. Furthermore, an AI Model Potential Cyber Threats 353 may store indicators of known threats, while an AI Model Normal Pattern of Life 354 may represent a general baseline, all of which are used by the comparison module 344 and cyber threat module 345 to assess device behavior.

The cyber security appliance 100 may communicate with the broader network environment through one or more I/O ports 395. These ports may serve as the physical interfaces for receiving data from network sensors (via the gatherer module 330) and for sending commands to other network devices, such as firewalls or switches, as part of an autonomous response action (via the autonomous response module 380). In an embodiment, these ports could be physical, such as Ethernet ports, or they could be virtual, such as API endpoints for ingesting data from cloud-based services.

The I/O ports 395 may handle the flow of all data that is ingested and analyzed by the appliance. For example, raw network packets or copies of industrial control communications may enter the appliance through the I/O ports 395 before being passed to the gatherer module 330 and the appropriate domain module (341 or 342) for processing. The efficient and reliable handling of data through these I/O ports 395 can be useful for the real-time performance of the entire cybersecurity appliance.

In an embodiment, the cyber threat module 345 may use hypothesis mechanisms that can include one or more of the AI model(s) 350 trained on how human cybersecurity analysts form cyber threat hypotheses. These models may be trained using supervised machine learning on human-led cyber threat investigations to learn the steps, data, metrics, and metadata required to support or refute a plurality of possible threat hypotheses. The module may also use one or more scripts or rules-based models to outline and execute the steps of an investigation. This allows the system to automate the complex reasoning process typically performed by a human expert, systematically testing potential threat scenarios against the observed data.

The training of the various AI model(s) 350 may occur both before and during deployment to ensure their accuracy and relevance. An initial training of an AI model for potential cyber threats (353) may occur using supervised or unsupervised learning on the characteristics and attributes of known threats, such as malware, insider threats, and specific types of industrial exploits (e.g., Stuxnet-like behavior). This pre-deployment training may configure each model to understand the particulars of a given domain, including its data types, protocols, and common devices. During deployment, these models may then use unsupervised learning to continuously adapt and learn the characteristics of new and emerging cyber-attack techniques observed in the live environment.

In certain embodiments, the one or more AI model(s) 350 responsible for modeling the normal pattern of life (e.g., 351, 352, 354) may be self-learning, using unsupervised machine learning algorithms to analyze patterns and establish a baseline of normal behavior. When first deployed, such a model may operate in an observation mode for a period of time, for example, one to two weeks, to gather enough data to establish a statistically reliable model of normal operations for each user and device. This self-learning capability may allow the system to create a highly bespoke and accurate ‘pattern of life’ model for each IT and OT entity it protects. This model may then be continuously updated during deployment, allowing it to adapt to the natural evolution of behavior within the organization.

To model what should be considered normal for a device or user, the system may analyze its behavior in the context of other similar entities within the network. The AI model(s) 350 may use unsupervised machine learning techniques to algorithmically identify significant groupings or clusters of entities, a task that may be difficult to perform manually. In an embodiment, the system may employ a number of different clustering methods, including matrix-based clustering, density-based clustering, and hierarchical clustering techniques, to create a holistic image of the relationships within the network. The resulting clusters may then be used by the architecture generation module 390 to create automatic groupings and to inform and refine the models of normative behavior for similar groups of users or devices.

The cyber threat module 345 and comparison module 344 may cooperate with the AI model(s) 350 trained on potential cyber threats to use advanced algorithms that account for ambiguity in the observed data. Instead of generating a simple binary output of ‘malicious’ or ‘benign,’ the mathematical algorithms may produce a probabilistic score, or a range of potential threat levels. This allows the system to rank alerts in a rigorous manner, enabling security teams and OT engineers to prioritize the threats that most urgently require action. This probabilistic approach also assists in avoiding the high rate of false positives that can be associated with more rigid, rule-based security systems.

In certain embodiments, the AI model(s) 350 trained on a normal behavior of entities in a domain under analysis (e.g., 351, 352) may perform threat detection through a probabilistic change in normal behavior through the application of an unsupervised Bayesian mathematical model. A Bayesian probabilistic approach may be used to determine periodicity in multiple time series data and identify changes across single and multiple time series data for the purpose of anomalous behavior detection. For example, a system being protected can include both OT and IT network domains under analysis, where raw data sources from each domain can be examined along with a large number of derived metrics that each produce time series data.

Although a specific embodiment for a cyber security appliance 100 for carrying out the various steps, processes, methods, and operations described herein is discussed with respect to FIG. 3, any of a variety of systems and/or devices may be utilized in accordance with embodiments of the disclosure. For example, the various modules shown as distinct blocks, such as the IT module 341 and the OT module 342, could be implemented as a single, integrated content analysis engine with specialized parsers for each domain. The elements depicted in FIG. 3 may also be interchangeable with other elements of FIG. 1-2 and 4-17 as required to realize a particularly desired embodiment.

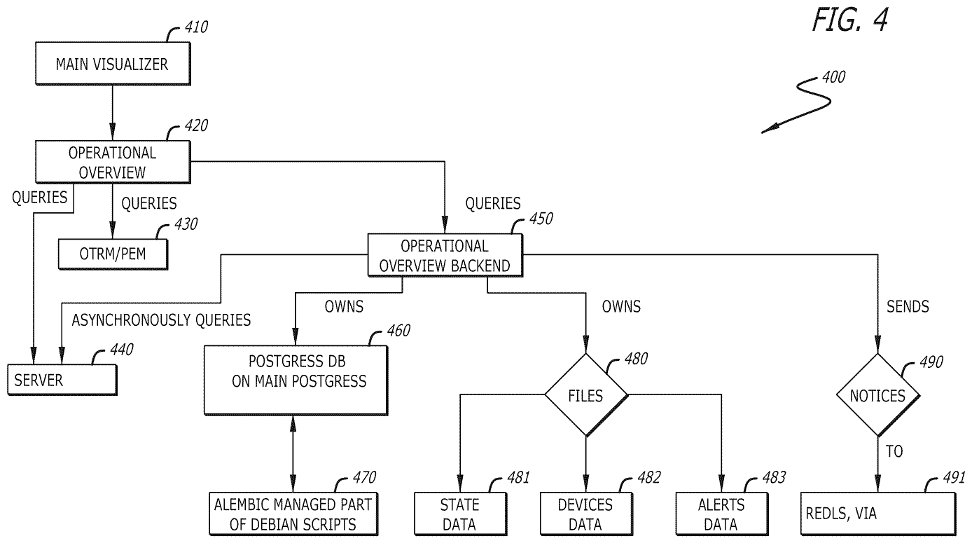

Referring to FIG. 4, a block diagram of an exemplary system architecture 400 for the Operational Overview is shown, in accordance with an embodiment of the disclosure. This architecture 400 illustrates the various software components and data flows that cooperate to produce the user interface and analytics for the operational health and asset management features of the cyber security appliance. The system 400 includes a main visualizer 410, an operational overview 420, an OTRM/PEM module 430, a Sabre server 440, an operational overview backend 450, a Postgres database 460, Alembic scripts 470, a files component 480 (which includes state data 481, devices data 482, and alerts data 483), a notices component 490, and a Redis component 491.

The main visualizer 410 represents the primary user interface (UI) of the entire cyber security appliance (100). This is the main “Threat Visualizer” application that a user, such as an IT security analyst or an OT engineer, logs into to monitor the network environment. The main visualizer 410 serves as the container for all other UI modules and dashboards, including the specialized operational overview 420. In an embodiment, the main visualizer 410 provides the top-level navigation, user authentication, and the windowing framework, and it loads the operational overview 420 as one of its sub-pages or primary dashboards.

The operational overview 420 is a specialized UI component or dashboard that is loaded within the main visualizer 410. This component is the “Operational Overview” itself, a purpose-built interface designed for the OT engineer persona. It functions as a central data aggregation hub for the user, sending queries to multiple backend services to gather all the data it needs to display. As shown, the operational overview 420 queries the OTRM/PEM 430 for risk data, the Sabre server 440 for core AI and pattern of life insights, and the operational overview backend 450 for the specific asset, alert, and architecture data related to this feature.

The OTRM/PEM 430 component is a specialized module configured to perform OT Risk Management (OTRM) and Proactive Exposure Management (PEM). This component is responsible for running attack path modeling and risk analysis on the monitored environment. It is configured to identify vulnerabilities, network misconfigurations, and high-risk IT/OT convergence pathways that could be exploited by an attacker. The operational overview 420 queries this module to retrieve risk scores, hygiene information, and data on risky connections, which are then displayed in the risk management portions of the UI.

The Sabre server 440 represents the core machine learning and AI engine of the cyber security appliance. This server hosts the pattern of life models and performs the core anomaly detection for the entire system. The operational overview 420 queries the Sabre server 440 to get the baseline behavior and anomaly data for both IT and OT assets. This data is used to populate graphs showing anomalous activity and to determine the status of devices, such as detecting the “absence of expected behavior” that triggers an operational health alert.

The operational overview backend 450 is the primary service component that handles the core business logic for the Operational Overview feature. It acts as an intermediary between the user-facing operational overview 420 and the underlying data persistence layers. This backend service receives queries from the UI, processes those requests, and retrieves or writes data. It is shown to own and manage the Postgres DB 460 and the file-based storage 480. Furthermore, it is responsible for formatting and sending asynchronous updates and notifications to the notices 490 bus.

The Postgres DB 460 is a dedicated relational database, specifically labeled as ‘DARKTRACE-OOB’ (Out-of-Band), which is hosted on the main Postgres instance of the appliance. This database is owned and managed by the operational overview backend 450 and is used to store persistent, structured data for the feature. This may include, for example, user-created architecture groupings, custom asset labels, saved filters, and other configuration data that needs to be retained permanently. The use of a dedicated database ensures that the data for this feature is properly indexed and can be queried efficiently by the backend 450.

The Alembic managed part 470 refers to the database schema management scripts associated with the Postgres DB 460. Alembic is a well-known Python-based tool used to handle database migrations and version control for database schemas. This component, which is owned by the Postgres DB 460, contains the scripts that define the table structures, columns, and relationships. It ensures that the schema of the Postgres DB 460 is correctly created and updated as new software versions of the cyber security appliance are deployed, preventing data corruption and ensuring compatibility.

The files 480 component represents a file-based persistence layer that serves as an alternative or supplement to the Postgres DB 460. This component, also owned and managed by the operational overview backend 450, may be used for caching, storing configuration, or persisting data that is more efficiently accessed as flat files rather than through relational database queries. This component is shown to be responsible for generating or managing several specific types of data files, including state data 481, devices data 482, and alerts data 483, which are used by the backend 450.

The state data 481 is a data file or set of files generated and managed by the files component 480. This file is likely used to store the current operational state of monitored devices in the network. This could include information such as whether a device is currently considered “online” or “offline,” or its last known run state (e.g., “Run,” “Stop,” or “Test”) as detected by the OT module. Storing this information in a file can provide a fast and efficient way for the operational overview backend 450 to retrieve the last-known status of all devices.

The devices data 482 is a data file or set of files that stores the inventory of identified assets. This file likely contains the information generated by the asset identification module. This data would include the list of all discovered devices, their MAC addresses, IP addresses, identified vendors, associated protocols, and the human-readable labels that have been applied to them. The backend 450 can use this file as a fast look-up cache to populate the asset browser.

The alerts data 483 is a data file or set of files that stores the operational health alerts generated by the system. When the cyber threat module and comparison module identify a new operational alert (e.g., “Device Offline,” “New ICS State Change”), that alert data may be persisted in this file. The operational overview backend 450 can then read this file to retrieve the list of active and historical operational alerts, which are then displayed in the specialized alerts view shown in FIG. 7.

The notices 490 component acts as an internal messaging or notification bus within the system. It is configured to receive formatted messages or “notices” from the operational overview backend 450. This component serves to decouple the backend logic from the appliance's core data bus; instead of the backend 450 writing directly to the core bus, it sends a notice to this dedicated component. This allows the system to send asynchronous updates or events to other services without blocking the main process thread of the backend 450.

The Redis, via ‘SabreAPI’ 491 component is the final destination for the messages processed by the notices 490 component. Redis is an in-memory data store, often used as a high-speed message broker or publish/subscribe bus. The notices 490 component sends its data to the core Redis instance via the ‘SabreAPI’, which is the Application Programming Interface for the Sabre Server 440. This integration allows the new operational health data and alerts to be published to the rest of the appliance's ecosystem, making this data available to other modules and allowing the UI (410, 420) to receive real-time updates.

In a first exemplary use case, an OT engineer logs into the cyber security appliance, which loads the main visualizer 410. The engineer then navigates to the “Operational Overview” 420 to check the status of the industrial environment. The operational overview 420 component immediately sends out parallel queries to its data sources. It sends a query to the OTRM/PEM 430 to get the latest risk scores and hygiene data for the OT network. It sends a query to the Sabre Server 440 to get any new pattern of life anomalies or threat data. Concurrently, it sends a query to the operational overview backend 450 for all assets and alerts. The backend 450 then queries its own datastores, retrieving the complete asset list from the devices data 482 file and the list of current alerts from the alerts data 483 file. The backend 450 aggregates this information and sends it back to the operational overview 420, which also receives the data from 430 and 440, combining all of it to render the complete dashboard for the user.

In a second exemplary use case, a new operational health event occurs in the network. For example, a critical sensor in the OT network stops communicating. This “absence of expected behavior” is detected by the core AI models running on the Sabre Server 440, which notifies the cyber threat module. The cyber threat module classifies this as a non-malicious “Operational Health Alert” and sends the new alert information to the operational overview backend 450. The backend 450 immediately persists this new alert, writing it to the alerts data 483 file. To ensure the UI is updated in real-time, the backend 450 also formats a message and sends it to the notices 490 component. The notices 490 component then publishes this new alert to the Redis bus 491, using the SabreAPI. The main visualizer 410, which is subscribed to these updates, receives the notice instantly and displays the new “Device Offline” alert in the operational alerts view without the user needing to refresh the page.

In a third exemplary use case, a user decides to create a new, custom asset grouping, which is a feature of the architecture generation module. Using the asset browser within the operational overview 420, the user selects five specific PLCs and two HMIs that are all part of a single physical process. The user then saves this selection as a new architecture group named “Production Line 1.” The operational overview 420 (UI) sends this new group definition, which includes the list of device IDs and the new name, to the operational overview backend 450. The backend 450, which is responsible for storing this persistent, user-defined data, connects to the Postgres DB 460. It then inserts new rows into the appropriate tables that define this new “Production Line 1” architecture. The schema of these tables is defined and maintained by the Alembic managed scripts 470. The backend 450 then sends a confirmation of success back to the UI. The user's custom architecture is now saved persistently, and the next time the user loads the UI, the operational overview 420 will query the backend 450, which will in turn query the Postgres DB 460 and retrieve this saved custom group.

Although a specific embodiment for a system architecture 400 for carrying out the various steps, processes, methods, and operations described herein is discussed with respect to FIG. 4, any of a variety of systems and/or devices may be utilized in accordance with embodiments of the disclosure. For example, the data persistence shown as two separate components (Postgres DB 460 and Files 480) could be consolidated into a single database, or the file-based system could be replaced with a different type of non-relational database. The elements depicted in FIG. 4 may also be interchangeable with other elements of FIG. 1-3 and 5-17 as required to realize a particularly desired embodiment.

Referring to FIG. 5, an exemplary user interface 500 for an Operational Overview Dashboard is shown, in accordance with an embodiment of the disclosure. This user interface 500 represents a single or unified view presented to an operator, such as an OT engineer or a site administrator. This dashboard is the primary visualization component of the operational overview and is generated by the user interface module. It is designed to provide a high-level, at-a-glance summary of the entire converged IT and OT environment by collating data from multiple underlying systems. The dashboard 500 is composed of several distinct widgets or panels, including an “Assets” widget 510, an “IT/OT CONVERGENCE” widget 530, an “OPERATIONAL ALERTS” widget 540, and a “RISK MANAGEMENT”widget 560.

The purpose and function of the visualization and grouping features are distinct from those found in competitor systems. While other tools may offer network visualization, their purpose is often limited to a single domain, such as asset inventory or vulnerability management. The present embodiments described herein are unique in that its purpose is to provide a “combined operational health, cyber threat management and risk profiling” in a single, correlated interface. This allows an operator to use the same visualization to investigate a cyber threat, monitor for an operational failure, and assess the risk posture of their assets simultaneously.

The “Assets” widget 510 is a panel within the dashboard 500 that is configured to provide a high-level summary of the asset inventory discovered on the monitored networks. This widget is populated with data generated by the asset identification module and retrieved from the devices data file. The widget 510 displays categorical information about the assets, for example, using donut charts and lists to show the total count of devices belonging to specific categories. As depicted in the embodiment, these categories can include “ICS Safety,” “ICS Workstation,” “ICS PLC,” “Server,” “Desktop,” and “Unknown,” allowing an operator to quickly understand the composition of their IT and OT environment and see how many devices of each type are currently being monitored by the cyber security appliance.

The “Asset count” graph 520 is a sub-component of the “Assets” widget 510 that is configured to display the trend of the total number of assets discovered over time. In this example, the graph 520 shows the asset count over the last 28 days, with a summary indicating that the “Asset count is up 4.34%.” This dynamic tracking is a useful function, as it provides immediate visual feedback when new devices are connected to the network. This allows an operator to instantly see if a new, unauthorized device has been plugged into a sensitive OT network, or to verify that new, legitimately-provisioned assets are being correctly monitored by the system. This stands in contrast to static systems that would be unaware of such changes.

The “IT/OT CONVERGENCE” widget 530 is a panel configured to highlight high-risk communications that cross the boundary between the Information Technology (IT) network and the Operational Technology (OT) network. This data is provided by the coordinator module, which correlates traffic from the IT module and the OT module. This widget 530 lists specific, observed connections, such as an IT server (e.g., uk-cbg-op-myb03.holdingsinc.com) communicating with a sensitive OT asset (e.g., “Intel Corporate Linux . . . Multi-protocol Safety”). This provides an operator with immediate visibility into this critical attack vector, allowing them to review and validate that these specific IT-to-OT communications are authorized and necessary for business operations.

The “OPERATIONAL ALERTS” widget 540 is a panel configured to display a prioritized list of operational health alerts. This widget is a useful component of the disclosure, as it separates alerts related to equipment failure, misconfigurations, and operational state changes from traditional cybersecurity threats, which would be displayed in a different interface. This widget 540, populated from the alerts data, allows an OT engineer to focus on the health and status of their industrial equipment. The examples shown, such as “ICS Reprogram Operational” or “New ICS Error Operational,” provide specific, actionable information about physical process events that require investigation. The widget 540 can be configured with tabs to show the “Top 5 Alerts,” “Most Recent Alerts,” or “Cyber Incidents,” allowing the operator to filter the information based on their immediate needs.

A driver for these embodiments and an improvement over traditional methods include providing feedback related to incidents where systems could not discern between an actual cyber threat, and an operational technology failure. In one such incident, a cascade of device failures can be initially investigated as a major cyber-attack, and it could take 18 to 24 hours to actually confirm that it was not a cybersecurity threat, and that it was actually an operational failing. The ability of the present system to distinguish between a cyber threat alert and an operational health alert directly solves this critical problem for operators of national infrastructure, who must be able to triage these two different event types immediately.

A significant advantage of this system is its ability to provide these new operational health alerts from passively ingested network traffic ingested for the purposes of cybersecurity monitoring. This is an additional benefit because the system is not typically designed to deploy another agent just to get our operational health. The system is thus utilizing data that is already ingested and classified for the provision of cybersecurity, which allows it to provide this dual benefit of cyber threat detection and operational health monitoring from a single, unified data source.

The alert trend graph 550 is a sub-component of the “OPERATIONAL ALERTS” widget 540. This graph 550 and its accompanying summary text are configured to provide historical context for the operational alerts. The graph plots the volume of alerts over a set period, such as the last twenty-eight days, allowing an operator to quickly identify trends. For example, a sudden spike in the graph, as depicted, would immediately indicate a new, significant, and potentially cascading failure or problem within the industrial environment. The summary text (shown with a placeholder “infinity more alerts”) would quantify this trend, enabling an operator to determine if the current volume of alerts is normal or anomalous.

The “RISK MANAGEMENT” widget 560 is a panel configured to provide a high-level, quantified summary of the overall cyber risk posture of the monitored environment. This widget 560 is populated with data from the OTRM/PEM module, which performs attack path modeling and vulnerability analysis. It displays a top-level “Risk Score” with a trend (e.g., “Risk Score is down 45%”) and provides a breakdown of the factors contributing to that score, such as “Impact,” “Damage,” and “Weakness.” This widget 560 is valuable as it distills complex risk metrics from hundreds or thousands of assets into a single, easy-to-understand visualization for a manager or operator.

The “TOP 10 HIGHEST-RISK ASSETS” list 570 is a sub-component of the “RISK MANAGEMENT” widget 560. This list 570 provides a specific, actionable, and prioritized enumeration of the exact devices on the network that are the largest contributors to the overall risk score shown in the widget 560. This list is a direct output of the OTRM/PEM module and provides granular detail to the operator. As shown in the example, specific industrial assets like a “Rockwell 1769-L16ER/B LOGIX5316ER CIP PLC” and a “WAGO EXAMPLE BACNET DEVICE” are identified. This allows an OT engineer to bypass guesswork and focus their remediation efforts (e.g., patching, segmentation, or configuration hardening) directly on the most vulnerable and critical assets in their environment.

In a first exemplary use case, an OT engineer begins their shift by logging into the main visualizer (410) and opening the operational overview dashboard 500. Their first glance is at the “OPERATIONAL ALERTS” widget 540, where they see a new “New ICS Error Operational” alert. They also notice on the alert trend graph 550 that there has been a small but unusual cluster of alerts over the past hour. Simultaneously, they look at the “Assets” widget 510 and notice in the “Asset count” graph 520 that a new asset was added to the network at approximately the same time the alerts began. This correlation, visible from a single screen, suggests that a newly connected device may be misconfigured and causing errors on the network, allowing the engineer to immediately begin their investigation with this context.

In a second exemplary use case, a manager wishes to assess the progress of their network hardening initiatives. They load the dashboard 500 and focus on the “RISK MANAGEMENT” widget 560. They are able to see that the overall “Risk Score” is “down 45% relative to the baseline,” providing a clear metric of improvement. They can then examine the “TOP 10 HIGHEST-RISK ASSETS” list 570 and confirm that the “Rockwell” PLC, which was at the top of the list last week, is no longer present, confirming that a recent firewall rule change to segment that device was successful in mitigating its risk. This provides a clear feedback loop to validate the effectiveness of security and operational changes.

In a third exemplary use case, a sophisticated cyber-attack begins. An attacker compromises an IT workstation and uses it to scan the network, eventually attempting to connect to a critical “ICS PLC.” The cyber security appliance detects this event and presents the correlated information across the dashboard 500. The “IT/OT CONVERGENCE” widget 530 would display the new, anomalous connection from the IT server to the ICS PLC. The “RISK MANAGEMENT” widget 560 would show a sudden spike in the “Risk Score,” and the “ICS PLC” asset would instantly appear at the top of the “TOP 10 HIGHEST-RISK ASSETS” list 570. The “OPERATIONAL ALERTS” widget 540 might also trigger a “New ICS Discover Operational” alert as the attacker's scan probes the device. An operator, seeing these simultaneous events across multiple widgets, can immediately recognize the pattern of a cross-domain attack and trigger an autonomous response to block the connection.

Although a specific embodiment for an exemplary user interface 500 for an Operational Overview Dashboard for carrying out the various steps, processes, methods, and operations described herein is discussed with respect to FIG. 5, any of a variety of systems and/or devices may be utilized in accordance with embodiments of the disclosure. For example, the various widgets (510, 530, 540, 560) could be rearranged, resized, or customized by the user to create a personalized dashboard that prioritizes the information most relevant to their specific role. The elements depicted in FIG. 5 may also be interchangeable with other elements of FIG. 1-4 and 6-17 as required to realize a particularly desired embodiment Referring to FIG. 6, an exemplary user interface 600 for asset management is shown, in accordance with an embodiment of the disclosure. This user interface 600 represents the “Assets” view, which is a sub-page or component of the main operational overview. This view is generated by the user interface module and serves as a detailed asset browser, providing a comprehensive and filterable inventory of all devices monitored by the cyber security appliance. Unlike a high-level summary dashboard, this interface 600 is designed for in-depth asset discovery, conditional searching, and inventory management. The interface 600 is composed of several useful components, including a header and navigation bar 610, a side panel 611 for quick and saved filters, an advanced filters bar 630, and a main asset list 620 where the detailed device information is displayed.

The header and navigation bar 610 is located at the top of the user interface 600 and serves to orient the user within the application. This bar 610 displays the title of the current view, which is “Assets.” It also provides other essential, high-level information, such as the “Timezone: Europe/London.” Displaying the time zone is a useful function as it provides context for any time-stamped data presented in the asset list 620, such as the “First Seen” column, ensuring that an operator in any part of the world can accurately interpret the chronological data.

The filter panel 611 is the main left-hand component of the “Assets” interface 600. This filter panel 611 acts as the primary hub for operators to apply filters to the main asset list 620. This allows a user to quickly pare down a potentially massive list of thousands of devices into a manageable subset. The filter panel 611 is logically organized into distinct sections to improve usability, including the “QUICK FILTERS” section 612 and the “SAVED FILTERS”section 613.

The “QUICK FILTERS” section 612 is a component within the filter panel 611 that provides a list of pre-configured, commonly used filters. These one-click filters allow an operator to immediately query the asset inventory for broad categories of devices without needing to manually construct a filter. The data for these filters is populated by the asset identification module. As shown in the embodiment, these filters can include “All devices,” status-based filters like “Most recently active,” device-type filters like “All PLCs,” or vendor-specific filters like “All Siemens.”

The “SAVED FILTERS” section 613 is another component within the filter panel 611, located beneath the quick filters. This section 613 is configured to store complex, conditional queries that an operator has built using the “ADVANCED FILTERS” bar 630 and chosen to save. This is a critical feature for operational efficiency, as an OT engineer may have a very specific set of assets they monitor daily (e.g., “All Rockwell PLCs on Subnet A that are running Firmware version 2.x”). They can create this complex filter once, save it, and it will appear in this section 613 for repeated use. In the depicted embodiment, this section shows “No Saved Filters,” indicating the current user has not yet saved any custom filter sets.

The main asset list 620 is the primary content area of the user interface 600. This component is a detailed, multi-column table that lists the individual assets discovered on the network, with each row representing a single device. This list 620 is populated by the operational overview backend, which retrieves the comprehensive inventory from the devices data file. This list 620 displays a wealth of enriched information for each asset, including its “Device Type” (e.g., “Server,” “Laptop”), “EOL Status” (End of Life), a “Risk” score, associated “Tags,” “IP Address,” “MAC Address,” “MAC Vendor,” “Operating System,” and “First Seen” timestamp. This granular, sortable view allows an operator to conduct detailed investigations and manage their asset inventory.

The “ADVANCED FILTERS” bar 630 is an interactive component located at the top of the main asset list 620. This bar 630 is configured to allow operators to build complex, conditional search queries using multiple logical steps. It provides a much more granular and powerful filtering capability than the “QUICK FILTERS” section 612. As shown in the embodiment, the bar 630 allows a user to select a data field (e.g., “Device Type”), a logical comparator (e.g., “is,” “is not,” “contains”), and a value (e.g., “ICS PLC”). An operator can chain multiple such conditions together using “AND” or “OR” logic to create a highly specific query.

The advanced filter controls 631 are the specific, interactive elements within the “ADVANCED FILTERS” bar 630 that the operator uses to build and manage their queries. These controls 631 include an “+Add Filter” button, which allows the user to add a new conditional row to the query. They also include a “Reset Filters” button to clear the current query, a “Save Filters” button to save the current set of conditions to the “SAVED FILTERS” section 613, and a “Search” button to execute the query and update the main asset list 620. These controls 631 provide the core functionality that enables the conditional searching capabilities of the asset browser.

In a first exemplary use case, an OT engineer wants to perform a simple inventory check. The engineer navigates to the “Assets” UI 600, which initially displays the full, unfiltered main asset list 620. The engineer wants to see only the industrial controllers. They move to the filter panel 611 and click the “All PLCs” button in the “QUICK FILTERS” section 612. The UI 600 then sends this filter request to the operational overview backend, which in turn queries the devices data for all assets where the “Device Type” is “ICS PLC.” The backend returns this filtered list, and the main asset list 620 refreshes to display only the PLCs, allowing the engineer to quickly see all controllers in their environment.

In a second exemplary use case, a compliance manager needs to generate a report of all “End of Life” (EOL) industrial devices on the network. The manager navigates to the UI 600 and uses the “ADVANCED FILTERS” bar 630. They use the controls 631 to add a filter where the “Device Type” “contains” “ICS.” They then use the “+Add Filter” control 631 to add a second condition: “AND” “EOL Status” “is” “End of Life.” After clicking “Search,” the main asset list 620 updates to show only the industrial devices that are operating with an EOL status. The manager can then use the “Export CSV” control (also part of 631) to export this specific list as a report for their compliance documentation.

In a third exemplary use case, a security analyst is investigating a high-risk server (“Server-A”) that was identified on the dashboard. The analyst pivots to the “Assets” UI 600 and uses the “ADVANCED FILTERS” bar 630 to find “Server-A.” They review its entry in the main asset list 620 and notice it has a tag of “AD FS Server.” Suspecting a compromised Active Directory federation, the analyst wants to see all other AD FS servers. They reset the filters and build a new query where “Tags” “contains” “AD FS Server.” The list 620 updates to show three servers. The analyst then sorts the list by the “Risk” column and immediately sees that all three servers have an “Active Threat” tag, indicating a widespread, correlated attack. The analyst can then use this information to take a comprehensive response action.

Although a specific embodiment for an exemplary user interface 600 for asset management for carrying out the various steps, processes, methods, and operations described herein is discussed with respect to FIG. 6, any of a variety of systems and/or devices may be utilized in accordance with embodiments of the disclosure. For example, the data columns shown in the asset list 620 could be customized by the user, allowing an operator to add or remove columns such as “Last Seen” or “Firmware Version” to tailor the view to their specific needs. The elements depicted in FIG. 6 may also be interchangeable with other elements of FIG. 1-5 and 7-17 as required to realize a particularly desired embodiment.

Referring to FIG. 7, an exemplary user interface 700 for managing operational alerts is shown, in accordance with an embodiment of the disclosure. This user interface 700 represents the “Alerts” view, which is a dedicated sub-page of the main operational overview and is generated by the user interface module. This view serves as a second, separate user interface view specifically tailored to the OT engineer persona, as it is scoped to display only operational health alerts. This is distinct from a first user interface view, such as the main appliance “Threat Tray,” which is configured to display cyber threat alerts. This separation is a useful component of the disclosure, allowing an operator to focus on equipment failures, misconfigurations, and process anomalies without being distracted by irrelevant IT security events.

The user interface 700 is composed of a header (displaying “Alerts” and “Timezone: Europe/London”), a filter and overview panel 710, and a main alert list panel 720. The filter and overview panel 710 is the main left-hand component of the “Alerts” user interface 700. This panel 710 serves as the primary navigation and filtering hub for an operator to manage the alerts presented in the main alert list panel 720. It is organized into several logical sections to improve usability, including an “ALERTS OVERVIEW” section which provides a high-level summary of alerts by priority, such as “Critical Alerts,” “Suspicious Alerts,” “Compliance Alerts,” or “Informational Alerts.” This panel 710 also includes a “QUICK FILTERS” section, allowing an operator to apply common, pre-configured filters like “All alerts” or “Compliance.” A “SAVED FILTERS” section is also provided, which would store any complex, user-defined queries (e.g., “All alerts for Production Line 1”) that an operator has built and saved for repeated use.

The main alert list panel 720 is the primary content area of the user interface 700, which contains the detailed, row-by-row enumeration of the alerts themselves. This panel 720 provides the advanced controls for managing this list, such as an “ADVANCED FILTERS” bar for creating complex, conditional queries (e.g., finding alerts where a “Trigger count” is “greater than” “5”). It also includes essential list management controls, such as a “Reset Filters” button to clear the current query, a “Save Filters” button to save the current query to the “SAVED FILTERS” section (in panel 710), a “Search” bar for keyword searching, and an “Export CSV” button to export the filtered list of alerts for reporting or external analysis.

The alert list 730 is the core component within the main panel 720, presenting the individual operational health alerts that have been generated by the cyber security appliance 100. This list is populated by the operational overview backend, which retrieves the alerts from the alerts data file after they have been generated by the cyber threat module and comparison module. This alert list 730 is specifically scoped to show only the new “Operational” model alert types. Examples shown in the embodiment include “New ICS Protocol Warning,” “Unmatched ICS Command Response,” “New ICS Action,” and “New ICS Error,” which provide specific, actionable information to an OT engineer about events in the industrial environment.

An individual alert entry 731 represents a single row within the alert list 730, providing a concise summary of a specific detected event. This entry 731 is configured to provide the most relevant information at a glance. As shown in the embodiment, the entry 731 includes a title describing the event (e.g., “10 occurrences of New ICS Protocol Warning Operational”), a score or priority (e.g., “32”), and a set of descriptive tags (e.g., “Experimental|Operational Overview|Informational”) that categorize the alert. It also provides a timestamp for the “LaTickets Detection,” allowing an operator to know precisely when the event occurred and to sort the alert list 730 chronologically to investigate an incident.

In a first exemplary use case, an OT engineer is monitoring the industrial environment when a critical piece of equipment, such as a reactor pressure sensor (980), suddenly fails and stops sending data. The Sabre server and comparison module detect this “absence of expected behavior” and generate a new operational health alert. This new alert is sent to the operational overview backend, persisted in the alerts data file, and published via the notices and Redis bus. The “Alerts” user interface 700, being subscribed to these updates, receives the new event in real-time. The alert list 730 is immediately updated with a new entry 731, titled “Device Offline: Reactor Pressure Sensor.” The OT engineer sees this new, high-priority alert appear at the top of the alert list 730, clicks on it to get more detail, and can immediately dispatch a maintenance team to the reactor, all without generating a false-positive cybersecurity incident for the IT security team.

In a second exemplary use case, an operator is investigating a recent, unplanned shutdown of a production line. They navigate to the “Alerts” UI 700 and want to see all events related to PLC state changes. In the “QUICK FILTERS” section of the filter panel 710, they use the “Search” bar to type “PLC”. The alert list 730 updates to show all alerts containing that term. The operator sees several alerts they are interested in, specifically “PLC Run Mode” and “PLC Stop Mode” alerts (as depicted in the alert list 730). To narrow the list further, they use the “ADVANCED FILTERS” in the main panel 720 to build a query: “Title” “contains” “PLC Stop Mode” AND “Time” “is after” “yesterday”. This provides a precise list of only the “Stop Mode” alerts from the last 24 hours, allowing the operator to correlate the exact time of the shutdown with other events in their maintenance logs.

In a third exemplary use case, a compliance manager is tasked with a quarterly audit of all safety system alerts. The manager navigates to the “Alerts” UI 700 and uses the “ADVANCED FILTERS” in the main panel 720 to create a complex query. They add a filter: “Tags” “contains” “ICS Safety” OR “Tags” “contains” “Compliance”. The alert list 730 updates to show all relevant safety and compliance alerts from the last quarter. Because this is a recurring task, the manager clicks the “Save Filters” button (part of panel 720). This action prompts them to name the filter (e.g., “Quarterly Safety Audit”), and it is then stored in the “SAVED FILTERS” section (in panel 710). The manager then clicks the “Export CSV” button (part of panel 720) to download this filtered list as a spreadsheet for their audit records. Next quarter, they can simply click the “Quarterly Safety Audit” link in the “SAVED FILTERS” section 710 to run the same report instantly.

Although a specific embodiment for an exemplary user interface 700 for operational alerts for carrying out the various steps, processes, methods, and operations described herein is discussed with respect to FIG. 7, any of a variety of systems and/or devices may be utilized in accordance with embodiments of the disclosure. For example, the alert entries 731 could be customized to display different fields, such as the source IP address of the device that triggered the alert or its asset label as defined by the asset identification module. The elements depicted in FIG. 7 may also be interchangeable with other elements of FIG. 1-6 and 8-17 as required to realize a particularly desired embodiment.

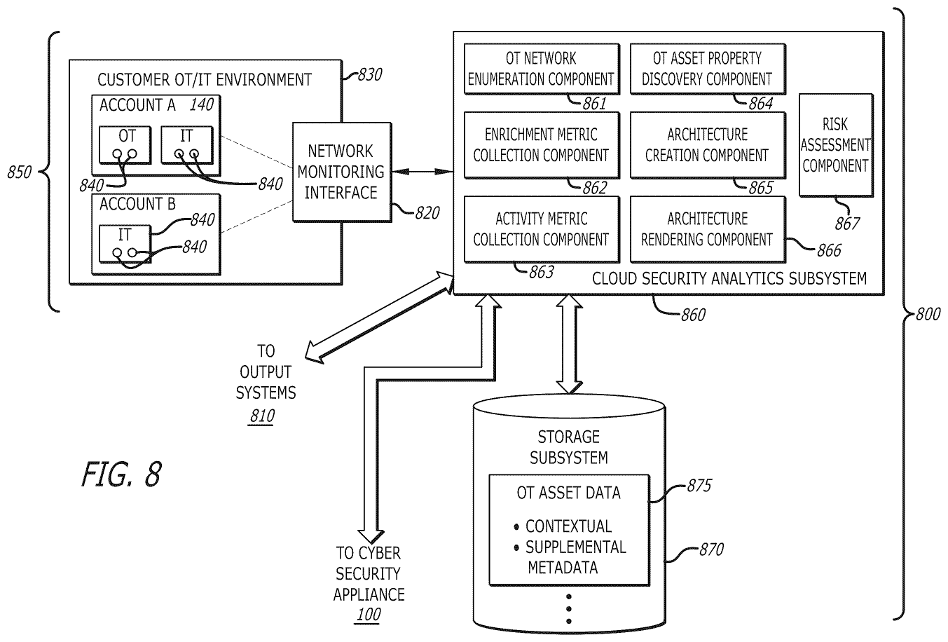

Referring to FIG. 8, a block diagram of a system 800 for a cloud security analytics subsystem is shown, in accordance with an embodiment of the disclosure. This system 800 illustrates a hybrid or cloud-centric deployment model, which can operate in conjunction with, or as an alternative to, the on-premises cyber security appliance 100. In this architecture, the data collection occurs at the network edge, while the intensive data processing, analysis, and storage are performed by a cloud-hosted subsystem 860. This model is particularly suited for organizations with multiple, geographically distributed sites, as it allows for the centralization of data and analysis in a single, scalable platform.

The system 800 includes a customer OT/IT environment 850 as the source of all network data. This customer environment 850 is the on-premises location, such as the industrial environment, that contains all the assets to be monitored. This environment 850 may be physically or logically segmented into multiple different sites or networks, which are represented in the diagram as Account A and Account B. This logical separation allows the system 800 to monitor and manage multiple distinct networks, such as a primary manufacturing plant and a separate research facility, all from within the same analytics subsystem.

Account A and Account B represent these individual, monitored networks within the broader customer OT/IT environment 850. For example, Account A could represent the entire corporate IT network, containing servers, workstations, and databases. In parallel, Account B could represent the entire industrial OT network, containing PLCs, HMIs, and industrial sensors. This separation allows the cloud security analytics subsystem 860 to ingest data from both environments and apply distinct analytical models before correlating the findings. Alternatively, Account A and Account B could represent two different physical factory sites, allowing a central security team to monitor both from a single, unified interface.

The IT/OT assets 840 are the individual devices that exist within the customer environment 850, specifically within each account. These assets 840 are the endpoints being monitored and represent the full spectrum of devices in a converged environment. This includes traditional IT assets such as servers, workstations, and firewalls, as well as critical OT assets such as Programmable Logic Controllers (PLCs), Human-Machine Interfaces (HMIs), Distributed Control Systems (DCS), sensors, and actuators. These are the devices that generate the network traffic that is the primary input for the entire analytics system 800.

The network monitoring interface 820 serves as the data collection point within the customer OT/IT environment 850. This interface 820 may be a physical or virtual appliance, such as a probe or sensor, that is deployed on-premises to passively monitor all network traffic. It is configured to capture the raw data packets generated by all IT/OT assets 840 across the various customer accounts. This interface 820 then forwards this captured traffic, often in a secure and compressed format, over the network to the cloud security analytics subsystem 860 for processing. This component acts as the bridge between the on-premises environment and the cloud-based analysis platform.

The cloud security analytics subsystem 860 is the core of the architecture shown in FIG. 8. This subsystem 860 is a cloud-hosted platform that receives the raw network data from the on-premises network monitoring interface 820. It is composed of a suite of specialized microservices or components (861-867) that are responsible for performing all the heavy lifting of data analysis. This includes device enumeration, property discovery, data enrichment, activity modeling, architecture creation, risk assessment, and rendering, all of which are performed in a scalable, cloud-based environment before the results are stored or sent to their final destinations.

The OT network enumeration component 861 is one of the first processing components in the cloud subsystem 860. This component is configured to ingest the raw traffic stream from the network monitoring interface 820 and perform the initial step of asset discovery. Its primary function is to analyze the traffic to find new and existing devices, enumerating them by their unique identifiers, such as their MAC and IP addresses. This component is responsible for creating and maintaining the foundational inventory of all assets 840 that exist on the customer's networks, which is the first step required before any further analysis can be performed.

The OT asset property discovery component 864 works in close coordination with the enumeration component 861. After a device has been enumerated, this component 864 is configured to perform a deeper analysis on its traffic to discover its specific properties. This component is responsible for parsing specialized industrial protocols (e.g., CIP, Modbus), identifying device types, and correlating MAC addresses with an internal database to determine the vendor (e.g., “Rockwell” or “Siemens”). This is the component that applies the human-readable labels and tags (e.g., “ICS PLC”) that are eventually stored as OT asset data (870) and displayed in the user interface.

The enrichment metric collection component 862 is configured to gather supplemental metadata about the discovered assets from external or third-party sources. Once the OT asset property discovery component 864 identifies an asset (e.g., a specific model of PLC), this enrichment component 862 may be configured to query external databases, such as a vulnerability database (CVE) or a third-party asset management system. It collects “enrichment” data, such as whether the device is “End of Life” (EOL) or has known critical vulnerabilities, which is crucial for accurate risk assessment.

The activity metric collection component 863 is configured to process the raw network traffic for each asset 840 and convert it into a structured format for behavioral analysis. This component is responsible for building the pattern of life data. For example, it logs all connections, protocols used, data volumes, and communication frequencies for each device. This time-series data of activity metrics is then used by the AI models to establish the baseline of normal behavior for every asset, which is the foundation for detecting anomalies, cyber threats, and operational health issues.

The architecture creation component 865 is configured to use the data from the other components to dynamically generate logical groupings and architectures. This component is the engine that implements the functionality of the architecture generation module. It takes the list of assets from the enumeration component 861, their properties from the discovery component 864, and their communication patterns from the activity component 863. It then runs clustering algorithms to automatically group assets by shared criteria (e.g., protocol, subnet, vendor) or to build user-defined architectures, which are then stored in the storage subsystem 875.

The architecture rendering component 866 is a specialized component that works with the architecture creation component 865. While the creation component 865 builds the logical data model of the architecture (e.g., “Group A contains devices X, Y, and Z”), the rendering component 866 is responsible for translating that data model into a visual format. It is configured to generate the data structures, such as node-edge graphs, that are required by a user interface (like a main visualizer or operational overview) to draw the architecture diagrams for the user, ensuring a consistent and accurate visualization of the groupings.

The risk assessment component 867 is configured to analyze all the available data to calculate a quantifiable risk score for assets and architectures. This component functions as the OTRM/PEM module. It ingests asset properties, enrichment data such as vulnerabilities, and connection pathways. It then runs attack path modeling and vulnerability analysis to identify high-risk assets and to quantify the overall risk posture of the environment.

The storage subsystem 875 is the central, cloud-hosted persistence layer for the entire analytics subsystem 860. This component may be implemented as a large-scale, redundant, and scalable cloud database (e.g., a data lake or a combination of SQL and NoSQL databases). It is configured to receive and store all the processed data generated by the various components (861-867). This includes the full asset inventory, the collected metrics, the defined architectures, the calculated risk scores, and all generated alerts, making it the central source of truth for the customer's environment.

The OT asset data 870 represents the schema or data model within the storage subsystem 875. This data is the primary output of the analysis pipeline. As shown in the embodiment, this data is not just raw traffic but is highly processed and enriched. It includes “Contextual” metadata, such as the human-readable labels, device types, and vendors discovered by component 864. It also includes “Supplemental Metadata,” such as the EOL status, vulnerabilities, and other enrichment data collected by component 862, all of which is stored and associated with each asset.

The system 800 provides for two primary output pathways for its data. One pathway is “To Output Systems” 810. This represents a generic data feed, such as an API or data stream, that allows the cloud security analytics subsystem 860 to send its processed findings to other, third-party systems. For example, this feed could be used to send all generated operational health alerts to a customer's existing maintenance and ticketing system, or to forward all asset inventory data to a corporate-wide asset management platform (CMDB).

The second, and primary, output pathway is “To Cyber Security Appliance”100. This data feed connects the cloud security analytics subsystem 860 back to the on-premises cyber security appliance 100. This illustrates the hybrid nature of the system 800. The cloud subsystem 860 performs the heavy-lifting of data processing, analysis, and storage, and then sends the finalized, enriched results (e.g., the asset list, the risk scores, the alerts) back to the on-premises appliance 100. The appliance 100 can then use this data to populate its local user interface for the on-site OT engineer and to trigger local autonomous response actions.

In a first exemplary use case, a new PLC (an IT/OT asset 840) is connected to the network in Account B. The on-premises network monitoring interface 820 captures the initial DHCP and ARP traffic from this new device and streams it to the cloud security analytics subsystem 860. The OT network enumeration component 861 logs the new MAC address and assigned IP, creating a new asset record. The OT asset property discovery component 864 then parses the device's subsequent CIP traffic, identifies it as a “Rockwell PLC,” and labels it as such. This new asset and its properties are then saved as OT asset data 870 in the storage subsystem 875 and are also sent via the output “To Cyber Security Appliance” 100. An OT engineer monitoring the asset browser on the local appliance 100 sees the new “Rockwell PLC” appear in their inventory almost instantly, fully labeled and identified, all without the appliance 100 having to perform the intensive discovery and parsing logic itself.

In a second exemplary use case, an operator wants to create a dynamic architecture group for all “End of Life” devices across their entire organization, which includes multiple sites (Account A and Account B). The data from both sites is already being collected by the interface 820 and processed by the cloud subsystem 860. The enrichment metric collection component 862 has already queried external databases and flagged several assets 840 in the storage subsystem 875 with an “EOL” status. The operator uses the UI on their local cyber-security appliance 100 to build this architecture. The cyber-security appliance 100 sends this request to the cloud subsystem 860. The architecture creation component 865 executes the query against the centralized storage subsystem 875, creating a new logical group that contains all “EOL” devices from both Account A and Account B. This new architecture is then rendered by component 866, stored, and sent back to the cyber-security appliance 100 for the user to view. This demonstrates how the cloud subsystem 860 can perform centralized analysis across distributed environments.

In a third exemplary use case, a new vulnerability is publicly disclosed for a common industrial protocol. The cloud security analytics subsystem 860 is updated. The enrichment metric collection component 862 performs a new query of external vulnerability feeds and identifies this new threat. In parallel, the risk assessment component 867 runs a new analysis. It queries the storage subsystem 875 for all assets 870 that the OT asset property discovery component 864 has tagged as using that vulnerable protocol. It identifies fifty such devices across both Account A and Account B. The risk assessment component 867 immediately raises the risk score for all fifty assets and sends this updated risk data back “To Cyber Security Appliance” 100. The operator, looking at their dashboard, sees their overall “Risk Score” increase and sees these newly vulnerable assets appear in the “TOP 10 HIGHEST-RISK ASSETS” list, allowing them to begin patching immediately. This entire risk re-assessment was performed centrally in the cloud 860 using the stored asset properties 870.

Although a specific embodiment for a system 800 for a cloud security analytics subsystem for carrying out the various steps, processes, methods, and operations described herein is discussed with respect to FIG. 8, any of a variety of systems and/or devices may be utilized in accordance with embodiments of the disclosure. For example, the cloud security analytics subsystem 860 could be deployed as a private cloud instance within the customer's own data center rather than as a public cloud service, providing a similar centralized analysis capability without data leaving the corporate network. The elements depicted in FIG. 8 may also be interchangeable with other elements of FIG. 1-7 and 9-17 as required to realize a particularly desired embodiment.

Referring to FIG. 9, another diagram of an exemplary industrial environment 900 is shown, in accordance with an embodiment of the disclosure. This diagram provides a more schematic or conceptual view of the converged IT/OT environment, which is similar to the physical industrial environment. This diagram 900 focuses on the relationship between the data and event monitoring systems (910, 912, 940) and the physical industrial components being controlled. The environment 900 includes an IT network visualization 910, an OT network visualization 912, a data and control flow 920, and a physical process visualization. The physical process components include a heat storage unit 930, a heat exchanger 960, a gas supply unit 970, a reactor 980, and a hydrocarbon liquid fuel production unit 990.

The IT network visualization 910 represents the Information Technology (IT) portion of the converged network. This visualization shows a graph or cluster of interconnected IT assets, such as servers, engineering workstations, historian databases, and other enterprise devices, similar to the network environment described in FIG. 1. This network visualization 910 is monitored by the cyber security appliance, and specifically by its IT module, to understand the pattern of life of these enterprise devices. One of the nodes in this network, node 911, is shown associated with alerts 940, indicating that this IT network is a source of security and operational data that is being analyzed by the system.

The node 911 represents a specific IT asset within the IT network visualization 910. This node 911 could be an engineering workstation used by a site administrator to manage the physical process, an HMI (Human-Machine Interface) server, or a historian database that pulls data from the OT network. In the diagram, this node 911 is explicitly linked to alerts 940, which conceptualizes that this specific asset is either the source of an alert (e.g., it has been compromised by malware and is behaving anomalously) or the destination of an alert (e.g., it is the HMI server where alerts are displayed to an operator). This highlights the system's ability to map abstract data events to specific, monitored assets.

The OT network visualization 912 represents the Operational Technology (OT) portion of the converged network. This graph shows a cluster of interconnected OT assets, such as the Programmable Logic Controllers (PLCs), Distributed Control System (DCS) controllers, actuators, and sensors that are directly controlling the physical process. This network is monitored by the specialized OT module of the cyber security appliance 100. The nodes in this visualization 912 are associated with “EVENTS,” which represent the real-time, cyclical operational data (e.g., “sensor value received,” “valve command sent,” “process variable update”) that constitutes the pattern of life for the industrial process. This is distinct from the IT-side “ALERTS” 940, as these OT “EVENTS” are often the normal, expected, high-frequency communications that the system learns to model.

The data and control flow 920 is represented by a large arrow pointing from the network visualizations (910, 912) to the physical process components (960, 980, 930). This arrow 920 conceptually represents the core function of the converged network: the data, events, and alerts from the IT and OT networks are used to monitor and control the physical machinery. This flow 920 also represents the monitoring footprint of the cyber security appliance, which ingests all this data to understand the real-time state of the physical environment. Furthermore, this flow 920 represents the critical IT/OT convergence boundary that the system is designed to protect from anomalous or malicious commands.

The heat storage unit 930 represents a specific, large-scale physical asset within the industrial process, similar to the components described previously. This unit 930 is a critical piece of operational technology, likely containing numerous sensors (e.g., temperature, pressure) and actuators (e.g., flow valves) that are all connected to the OT network 912. The cyber security appliance monitors the pattern of life of this heat storage unit 930, learning its normal thermal charge and discharge cycles. An “operational health alert” 940 could be generated if, for example, its temperature sensors stop sending data, or if they report anomalous readings that indicate a physical failure or inefficiency in the unit.

The alerts 940 represent the output of the cyber security appliance's 100 analysis, specifically from the cyber threat module and comparison module. These alerts 940 are shown conceptually linked to the IT network 910 and node 911. This signifies that alerts can be both cybersecurity threats (e.g., “Anomalous IT/OT Convergence from Node 911”) or operational health alerts (e.g., “Node 911 Offline”). These generated alerts 940 are then processed by the user interface module and presented to a site administrator, for example, in the operational alerts dashboard or the dedicated alerts list.

The heat exchanger 960 is another critical OT asset within the physical process, responsible for transferring thermal energy from one medium to another, such as in a recuperator loop. As part of the industrial process, this device is heavily instrumented with sensors (e.g., inlet temperature, outlet temperature, flow rate) and controllers that are monitored as part of the OT network 912. The system's OT module would learn the normal, correlated pattern of life of these sensors, such as the expected mathematical relationship between the inlet and outlet temperatures on both of its circuits. A deviation from this learned model, such as the outlet temperature failing to respond to an inlet temperature change, would be detected as an operational health anomaly and would result in an alert (940).

The gas supply unit 970 represents the intake or feedstock component for the industrial process. As shown, it handles various material inputs such as H2 (hydrogen), CO (carbon monoxide), and CO2 (carbon dioxide), which are fed into the reactor 980. This gas supply unit 970 would be controlled by PLCs and automated valves that are part of the OT network 912. The cyber security appliance 100 would monitor the commands sent to these valves via the data and control flow 920, learning the normal “recipe” or sequence for a production run. An anomalous command, such as an attempt to open the H2 valve at the wrong time or from an unauthorized IT workstation 911, would be immediately flagged as a high-risk threat.

The reactor (RX) 980, which is also labeled as part of a recuperator loop, represents the core processing unit of the industrial environment 900. This is a highly sensitive and complex piece of OT, where the thermochemical conversion occurs. The reactor 980 is monitored by a dense array of sensors (for temperature, pressure, etc.) and is managed by high-availability controllers on the OT network 912. The system 100 would model the complex, multi-variate pattern of life of this reactor, understanding the relationships between its temperature, pressure, and gas supply units 970. An anomaly here, such as a pressure reading deviating from its learned correlation with temperature, could represent a critical and dangerous operational failure, and would be immediately flagged as a high-priority operational health alert 940.

The hydrocarbon liquid fuel production unit 990 represents the final output stage of the industrial process. This unit 990 takes the processed material from the reactor 980 and gas supply 970 and completes the synthesis into a final product. This stage would have its own set of OT controls, sensors, and actuators to manage the final chemical conversion, refinement, and storage. The cyber security appliance 100 monitors this stage as well, ensuring that the devices are operating as expected and are not being subjected to anomalous commands. The entire chain, from gas supply 970 to reactor 980 to final production 990, is modeled as a single, holistic process by the monitoring system.

In a first exemplary use case, an OT engineer is monitoring the environment 900. A critical temperature sensor on the heat exchanger 960 fails and stops transmitting its data. This sensor is a node within the OT network visualization 912 that normally sends an “EVENT” (a data packet) every two seconds as part of its normal pattern of life. The OT module and comparison module detect this “absence of expected behavior” because the cyclical “EVENT” is no longer seen. The cyber threat module determines this is not correlated with any cyber threat from the IT network 910. It therefore generates a high-priority “operational health alert” 940, which is associated with the heat exchanger 960 and sent to the administrator's dashboard (as seen in FIG. 5), allowing for immediate maintenance to be dispatched.

In a second exemplary use case, a sophisticated cyber attack begins. An attacker compromises an IT workstation, represented as node 911 in the IT network visualization 910. This workstation is normally used for administrative tasks. The attacker, now controlling node 911, attempts to send a new, anomalous command (part of flow 920) directly to the gas supply unit 970 to shut down the flow of H2. The cyber security appliance 100 detects this communication. The coordinator module correlates that the source is an IT asset 911 and the destination is a sensitive OT asset. The OT module flags the command as anomalous, as this IT workstation has never communicated with this OT device before, which is a severe deviation from the pattern of life model. The cyber threat module generates a critical “IT/OT Convergence” alert 940 and can signal the autonomous response module (380) to block this specific malicious connection before it can cause a physical process shutdown.

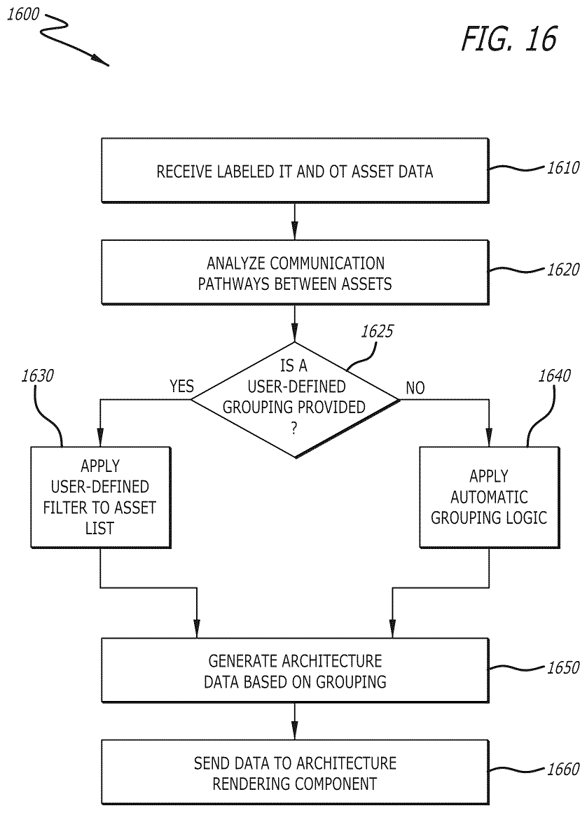

In a third exemplary use case, a site administrator wants to create a visual grouping of their most critical process components. Using the architecture generation module, the administrator creates a new architecture (as described in FIG. 16) and manually groups the heat storage unit 930, heat exchanger 960, reactor 980, and fuel production unit 990. These assets are all part of the OT network 912. The system 100 now treats this as a high-priority group. Later, a new, unknown device connects to the network and begins communicating with the reactor 980. Because the reactor 980 is part of this high-priority, user-defined architecture group, the cyber threat module automatically escalates the priority of the “New Device” alert 940, bringing it to the immediate attention of the administrator and flagging the new device as a potential, immediate threat to the core production process.

Although a specific embodiment for an exemplary industrial environment 900 for carrying out the various steps, processes, methods, and operations described herein is discussed with respect to FIG. 9, any of a variety of systems and/or devices may be utilized in accordance with embodiments of the disclosure. For example, the separation of IT network visualization 910 and OT network visualization 912 is conceptual; in a real-world user interface, these nodes could be combined into a single, unified topology graph, with visual indicators (such as color or tags) to differentiate the IT and OT assets. The elements depicted in FIG. 9 may also be interchangeable with other elements of FIG. 1-8 and 10-17 as required to realize a particularly desired embodiment.

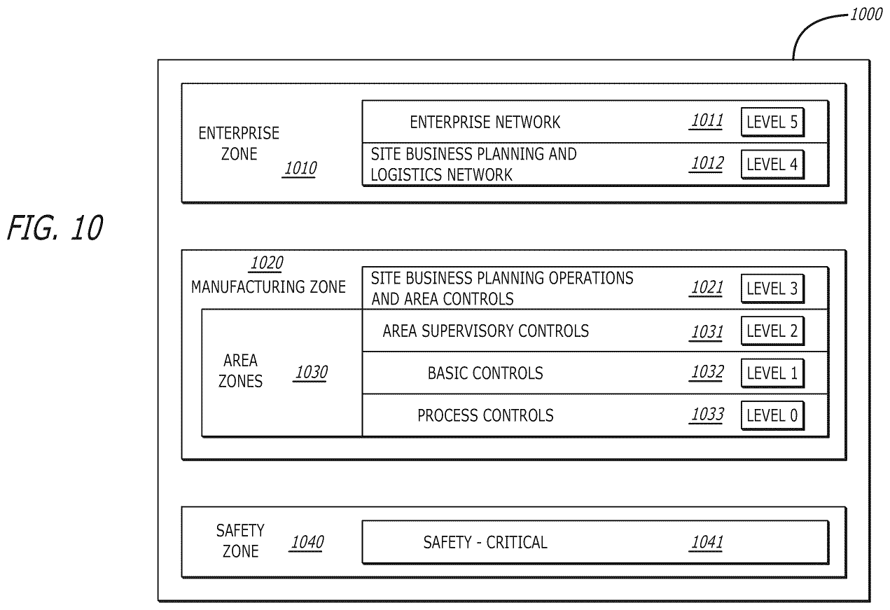

Referring to FIG. 10, a diagram of a model 1000 for industrial control systems is shown, in accordance with an embodiment of the disclosure. As those skilled in the art will recognize, the model 1000 can be a standard, conceptual framework such as the Purdue Model used in the industrial automation industry to illustrate the segmentation and hierarchy of a converged enterprise network. This model 1000 provides context for the present disclosure by logically separating the traditional Information Technology (IT) systems from the real-time Operational Technology (OT) systems. The cyber security appliance 100 is configured to monitor, analyze, and understand the communications that occur within and between these different levels. The model 1000 is hierarchically organized into distinct zones, including the Enterprise Zone 1010, the Manufacturing Zone 1020, the Area Zones 1030, and the Safety Zone 1040.

The model 1000 can represent the entire converged network infrastructure of an organization. This includes all assets, from the top-floor corporate servers in the IT environment down to the physical sensors and actuators on the factory floor in the OT environment. The cyber security appliance 100 is designed to provide a holistic, unified monitoring solution for this entire model 1000. It can achieve this by applying different specialized AI models, such as the AI Model IT Network Pattern of Life for the upper levels and the AI Model OT Network Pattern of Life for the lower, industrial levels.

The Enterprise Zone 1010 represents the traditional IT portion of the network. This zone 1010 is where corporate business functions are performed and is generally managed by the IT department. It is typically a carpeted, office-style environment, distinct from the industrial zones. This zone 1010 contains the assets that are most often connected to the internet and cloud platforms, making it a primary vector for external cyber threats. The IT module of the cyber security appliance is primarily responsible for monitoring the assets and traffic within this zone 1010. The Enterprise Zone 1010 is further broken down into Level 5 1011 and Level 4 1012.

Level 5 1011, labeled “Enterprise Network,” represents the highest and most outward-facing layer of the IT infrastructure. This level 1011 includes the corporate-wide systems, such as the main email servers, enterprise-wide databases, central data centers, and the primary firewalls and gateways connecting the organization to the internet and public cloud platforms. From a security perspective, Level 5 1011 is the primary entry point for external threats. The cyber security appliance 100 is configured to monitor traffic from this level for any attempts to move “down” the Purdue model 1000 to attack the lower, more sensitive levels.

Level 4 1012, labeled “Site Business Planning and Logistics Network,” is the layer of the IT network that is specific to the local site or facility, such as the industrial environment. This level 1012 sits below the global corporate systems 1011 but remains above the real-time manufacturing controls. This level 1012 hosts the business management applications for the plant, such as Enterprise Resource Planning (ERP) servers that manage production schedules, and Manufacturing Execution Systems (MES) that track work orders and material inventory. The cyber security appliance 100 learns the pattern of life of these servers, including their normal communication patterns with the levels above and below them.

The Manufacturing Zone 1020, which contains Level 3 1021, serves as the critical boundary, or “demilitarized zone” (DMZ), that separates the IT systems in the Enterprise Zone 1010 from the real-time OT systems in the Area Zones 1030. This zone 1020 is the primary point of IT/OT convergence. Communications that cross this boundary are subject to the highest scrutiny by the cyber security appliance 100, as they represent the most significant risk vector for an attacker pivoting from a compromised IT asset to attack the physical industrial process. The “IT/OT CONVERGENCE” widget in the user interface is specifically designed to visualize anomalous traffic that crosses into or out of this Manufacturing Zone 1020.

Level 3 1021, labeled “Site Business Planning Operations and Area Controls,” represents the supervisory control layer of the facility. This level 1021 is where human operators and site administrators typically manage the industrial process. Assets at this level include Human-Machine Interface (HMI) servers, historian databases (which log process data for analysis), and operational management workstations. An HMI at this level would display the status of the entire plant and allow an operator to issue high-level commands, such as “Start production run” or “Initiate shutdown sequence,” which are then sent down to the lower control levels.

The Area Zones 1030 represent the heart of the real-time OT network. This zone 1030 is where the actual, high-speed, and often deterministic industrial control takes place. This zone contains the specialized hardware, such as PLCs and DCS controllers, that directly manages the physical machinery. The traffic here primarily uses industrial protocols (e.g., CIP, Modbus, Profinet) and is the main focus of the OT module and the AI Model OT Network Pattern of Life. This zone 1030 is further segmented into Level 2 1031, Level 1 1032, and Level 0 1033, representing the functional hierarchy of the control system itself.

Level 2 1031, labeled “Area Supervisory Controls,” typically hosts the supervisory controllers, such as the main PLCs or DCS controllers for a large, coordinated process area. For example, a single, powerful controller at this level 1031 might be responsible for managing the entire fuel synthesis facility. It receives high-level commands from the Level 3 HMI 1021 (e.g., “Make fuel”) and translates them into a sequence of specific, real-time instructions that are then passed down to the basic controllers at Level 1 1032.

Level 1 1032, labeled “Basic Controls,” contains the dedicated controllers for individual pieces of equipment. This is where the specific PLC that controls the heat exchanger, the dedicated controller for the gas supply unit, or the controller for a single heliostat would reside. These devices execute simple, repetitive, and time-critical logic (e.g., “IF temperature>1500 C, OPEN valve 2B”). The asset identification module is crucial at this level for identifying these often-cryptic devices and applying human-readable labels so an operator can understand their function.

Level 0 1033, labeled “Process Controls,” is the lowest level of the model and represents the physical process itself. This level 1033 is the machinery—the actual sensors (e.g., temperature sensors, pressure sensors, flow meters), actuators (e.g., electric motors, hydraulic valves, pumps), and I/O blocks that are physically wired to the Level 1 1032 controllers. The cyber security appliance 100 monitors this level indirectly by analyzing the data packets on the Level 1 and Level 2 networks. An operational health alert, such as a “Device Offline” alert, is often triggered when a Level 0 sensor fails and stops sending data, which is detected by the appliance as a missing cyclical “EVENT” from its parent controller at Level 1.

The Safety Zone 1040, which contains the “Safety-Critical” level 1041, represents a parallel and independent control system. This zone 1040 is dedicated exclusively to the Safety Instrumented System (SIS). These systems are not responsible for process control, but rather for emergency shutdown procedures to protect personnel, the environment, and the equipment itself. This zone 1040 is intentionally segregated from the main Area Zones 1030 to ensure its integrity, even if the main control system fails or is compromised.

Level 1041, “Safety-Critical,” contains the dedicated, redundant safety PLCs and emergency stop (E-stop) systems. These devices monitor the most critical parameters (e.g., a pressure of the reactor) and have the authority to override all other controls to force a safe shutdown. The pattern of life for this level 1041, as learned by the AI Model OT Network Pattern of Life, would be one of predictable, silent monitoring. Therefore, the cyber security appliance 100 would treat any unexpected communication to this level, especially a write command originating from the Enterprise Zone 1010, as an extreme and immediate cyber threat, requiring an autonomous response.

In a first exemplary use case, a sophisticated IT/OT convergence attack is simulated. An attacker compromises an IT workstation at Level 5 1011 via a phishing email. They move laterally to a site planning server at Level 4 1012. This server 1012 is permitted to communicate with the HMI server at Level 3 1021, so the attacker uses this legitimate path to compromise the HMI. From the HMI at Level 3, the attacker attempts to send a malicious “Stop Unit” command to a PLC at Level 1 1032 that controls the hydrocarbon liquid fuel production. The cyber security appliance detects this: the coordinator module flags the IT/OT convergence, and the OT module flags the “Stop Unit” command as anomalous, as it did not originate from the supervisory PLC at Level 2 1031 as expected by the “pattern of life.” The cyber threat module generates a critical alert, and the autonomous response module can be configured to block this specific command from the Level 3 HMI, preventing the shutdown.

In a second exemplary use case, an operational health failure occurs. A physical pressure sensor, a Level 0 1033 device, on the reactor fails. This sensor is wired to a “Basic Control” PLC at Level 1 1032 This PLC 1032 is part of a control loop and is programmed to send its pressure reading to the “Area Supervisory Control” PLC at Level 2 1031 every 500 milliseconds. The OT module and comparison module, referencing the AI Model OT Network Pattern of Life, have learned this 500 ms cyclical “pattern of life.” When the sensor fails, the data stops. The comparison module detects this “absence of expected behavior.” The cyber threat module sees no correlated cyber threat from the Enterprise Zone 1010 and correctly classifies this as an “Operational Health Alert.” This alert is then sent to the “OPERATIONAL ALERTS” widget (540) on the HMI at Level 3 (1021) for the OT engineer to investigate the physical sensor failure.

In a third exemplary use case, a risk assessment is performed based on the Purdue Model 1000. An operator uses the architecture generation module to create a new, dynamic architecture group for all assets in the “Manufacturing Zone” 1020 and “Area Zones” 1030. The cyber security appliance 100 populates this group with all assets it has identified as belonging to Levels 0-3. The enrichment metric collection component and risk assessment component then analyze this group. They discover that a Level 3 1021 HMI server is running an “End of Life” EOL operating system, and a Level 2 1031 PLC has a known critical vulnerability. Because these assets are at high, privileged levels of the Purdue model 1000 and have direct pathways to the lower-level controls, the risk assessment component assigns them an extremely high-risk score. These assets immediately appear in the “TOP 10 HIGHEST-RISK ASSETS” list on the dashboard, allowing the operator to prioritize patching these critical control-layer devices.

Although a specific embodiment for the Purdue Model 1000 for carrying out the various steps, processes, methods, and operations described herein is discussed with respect to FIG. 10, any of a variety of systems and/or devices may be utilized in accordance with embodiments of the disclosure. For example, the strict hierarchy of the Purdue Model 1000 may not be present in all networks, and the cyber security appliance 100 may be configured to analyze “flat” networks where IT and OT devices from different levels are intermingled on the same subnet. The elements depicted in FIG. 10 may also be interchangeable with other elements of FIG. 1-9 and 11-17 as required to realize a particularly desired embodiment.

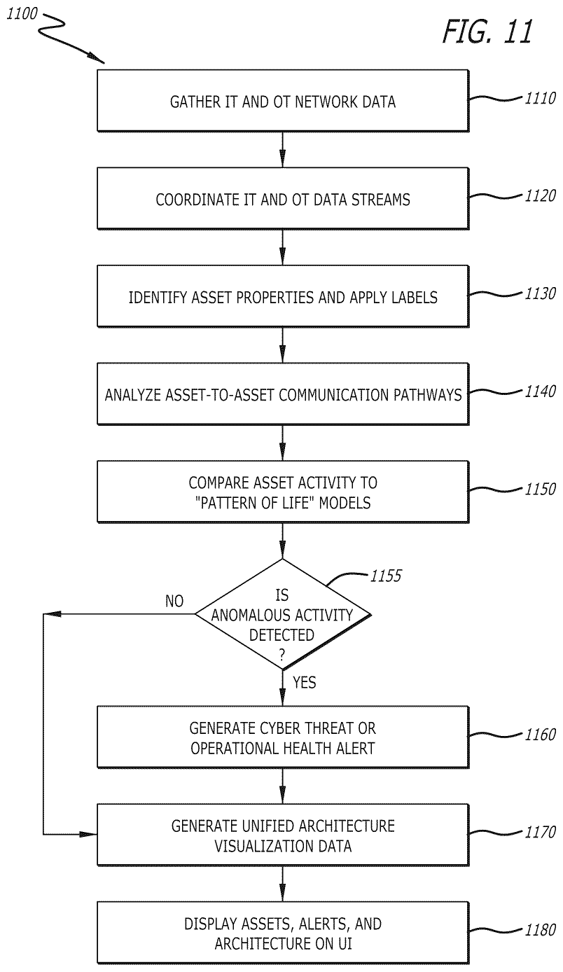

Referring to FIG. 11, a flowchart depicting a process 1100 for overall cybersecurity and operational health analysis in accordance with various embodiments of the disclosure is shown. In many embodiments, the process 1100 can gather IT and OT network data (block 1110). This data can be collected from a variety of sources within the converged network environment. For example, data can be gathered by passively monitoring network traffic from a SPAN port or network tap, which is a common practice in sensitive OT environments to avoid disruption. In a non-limiting example, this gathering can also be augmented by actively querying certain devices, such as IT workstations or enterprise servers, to retrieve log files or configuration details. It is contemplated that data may also be ingested from third-party systems, such as pulling asset information from an existing asset management database or vulnerability data from a cloud-hosted security service.

The cyber security appliance 100 is specifically designed to operate effectively in highly secure or “air-gapped” OT environments. The system's passive monitoring approach allows it to work in a data diode-type environment, so it can only ever receive data from a network. This is a critical capability, as it does not require bi-directional communication, which is often forbidden in high-security industrial zones. All labeling, modeling, and alerting can be performed using only this one-way, passively ingested data stream.

In a number of embodiments, the process 1100 can coordinate IT and OT data streams (block 1120). This coordination is performed to create a unified and holistic view of the entire converged environment, allowing events from both domains to be correlated. For example, this can involve a coordinator module that receives separate data feeds from an IT module and an OT module and synchronizes them based on timestamps or shared identifiers like IP addresses. It is contemplated that the data streams can be normalized into a common format, such as a standardized JSON schema, before being sent to the analytical engines. This allows different analytical models to process data from either stream without requiring specialized parsers for each.

In more embodiments, the process 1100 can identify asset properties and apply labels (block 1130). This is a step for providing human-readable context to operators, who may not recognize a device by its IP or MAC address alone. For example, the process can involve parsing industrial protocol traffic to extract vendor and device type information (e.g., “Rockwell PLC” or “Siemens HMI”) using a rules-based engine from the asset identification module. In another embodiment, this identification can be done by cross-referencing a device's MAC address with an internal or external OUI (Organizationally Unique Identifier) database to determine the manufacturer. It is contemplated that users can also manually apply or override labels, such as “Critical Production Line PLC,”to provide specific operational context.

In further embodiments, the process 1100 can analyze asset-to-asset communication pathways (block 1140). This analysis helps build a pattern of life model by mapping out which devices normally communicate with each other, using which protocols, and at what frequency. For instance, the system can learn that an HMI server in the IT zone normally communicates with ten specific PLCs in the OT zone using read-only commands, but never with a safety-instrumented system (SIS). This analysis is not a one-time snapshot; it can be continuous, allowing the system to dynamically update its pattern of life model as the network environment evolves. In a non-limiting example, this analysis can be used to identify high-risk IT/OT convergence pathways that represent a significant attack vector, such as an IT workstation that has a direct and unnecessary communication path to a critical OT controller.

In additional embodiments, the process 1100 can compare asset activity to pattern of life models (block 1150). This step involves the core anomaly detection engine, which takes the real-time communication pathways (from block 1140) and evaluates them against the learned behavioral baselines. For example, a pattern of life model for an OT device may define a highly cyclical pattern of communication, such as sending a specific data packet every 500 milliseconds. This comparison step would check if the real-time activity matched this learned pattern in terms of timing, protocol, and data size. In another embodiment, this comparison can be multi-faceted, comparing the activity not just to the device's own baseline but also to the baseline of its peer group (e.g., all other PLCs of the same model). It is contemplated that this comparison generates a probabilistic score indicating how much the current activity deviates from the established norm.

In still more embodiments, the process 1100 can determine if anomalous activity is detected (block 1155). This determination is made by consuming the comparison results previously generated. For example, this determination can be based on a probabilistic score, where a deviation from the baseline model must exceed a certain threshold to be considered anomalous. It is contemplated that this determination can also be based on a deterministic rule, such as “any communication from an IT device to a safety PLC is anomalous.” In another alternative, the determination can be a combination of factors, such as a new, never-before-seen communication protocol being used by a device and that device's CPU load metric being outside its normal bounds.

If anomalous activity is detected, the process 1100 can generate a cyber threat or operational health alert (block 1160). This dual classification is a useful function, allowing the system to distinguish between a malicious event (a cyber threat) and an equipment failure (an operational health alert). For example, an anomalous command sent from an IT workstation to a PLC would be flagged as a high-risk cyber threat. In a non-limiting example, this generation can involve correlating the anomaly with other threat intelligence; if the anomalous connection is to a known command-and-control IP address, its threat score is escalated. It is contemplated that the operational health alerts can be just as critical, such as detecting the “absence of expected behavior” when a critical sensor stops sending its cyclical data, indicating an equipment failure.

It is a distinction and improvement over the prior art that the present disclosure includes operational health monitoring focused on the cyber and network context of OT devices, rather than competing with traditional tools and systems that process anomaly management. The system may not be configured, for example, to analyze low-level 24-volt sensor data to determine if a physical process variable is out of specification. Instead, embodiments can be configured to stay in the cyber incident management space and bridge the gap into operational monitoring by analyzing IP-based communications and their patterns. This allows the system to identify operational health issues like device failures or state changes that are visible on the network, without overstepping into the specialized domain of process control analysis.

However, if the process 1100 determines that anomalous activity is not detected, the process 1100 can generate unified architecture visualization data (block 1170). This data is used to update the user interface, providing a real-time, dynamic view of the network and its assets. For example, this data can be generated by an architecture generation module and sent to the user interface module to render the asset groupings. In an embodiment, this data is formatted as a node-edge graph, where assets are nodes and communications are edges, allowing for a topology map to be drawn. It is contemplated that this visualization data is also used to update asset lists and dashboards, such as those shown in other figures, with the latest status and properties.

In yet further embodiments, the process 1100 can display assets, alerts, and architecture on a user interface (UI) (block 1180). This involves the user interface module rendering the data generated and any alerts onto a screen for an operator. For example, the system can display a high-level dashboard that provides a single unified view of all assets, alerts, and risk metrics. In another embodiment, the UI can be a more detailed asset browser, where an operator can use advanced filters to search the asset inventory. It is contemplated that this can also include a dedicated alerts view (as discussed previously) that is specifically scoped to show only the operational health alerts, allowing an OT engineer to manage equipment failures without being distracted by IT-focused cyber alerts.

Although a specific embodiment for a process 1100 for overall cybersecurity and operational health analysis for carrying out the various steps, processes, methods, and operations described herein is discussed with respect to FIG. 11, any of a variety of systems and/or processes may be utilized in accordance with embodiments of the disclosure. For example, the order of the blocks may be modified, such as identifying asset properties (block 1130) before coordinating the data streams (block 1120). The elements depicted in FIG. 11 may also be interchangeable with other elements of other figures as required to realize a particularly desired embodiment.

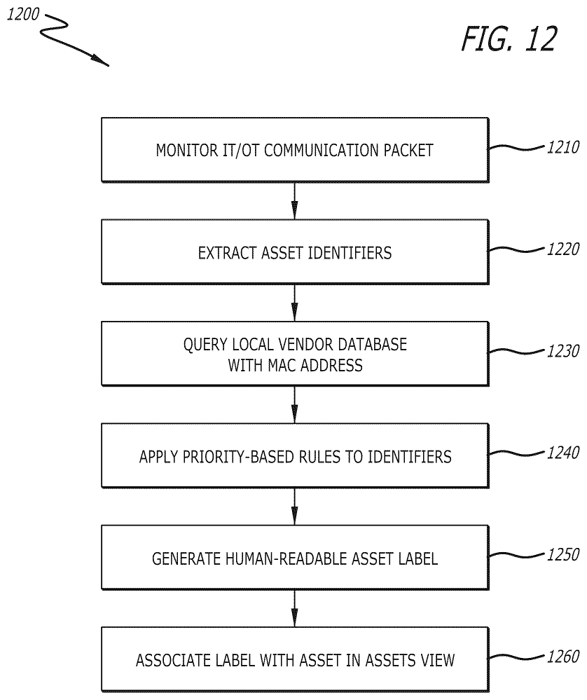

Referring to FIG. 12, a flowchart depicting a process 1200 for asset identification and labeling in accordance with various embodiments of the disclosure is shown. The asset identification and labeling process 1200 is particularly focused on OT assets because they often lack the clear, human-readable identifiers common in IT environments. Traditional IT devices, such as servers and workstations, including IT devices typically have some useful name already, such as a host name. In contrast, OT devices like PLCs or sensors may only be identifiable by an IP address or cryptic MAC address. Therefore, the labeling process 1200 provides a significant benefit by applying clear, purposeful labels (e.g., “S7 Siemens PLC”) to these OT assets, which is less critical for most IT devices.

In many embodiments, the process 1200 can monitor an IT/OT communication packet (block 1210). This monitoring is a step for passively discovering and identifying assets without actively probing the network, which is critical in sensitive operational technology environments. For example, this monitoring can be performed by a sensor or probe connected to a SPAN or mirror port on a network switch, allowing it to inspect a copy of all traffic without being in-line. In a non-limiting example, this monitoring can also be performed on a specific network segment, such as a VLAN or subnet that is known to contain critical OT assets. It is contemplated that while passive monitoring is one approach, this step could also involve receiving communication packets that are actively forwarded to the monitoring system from a firewall or router.

In a number of embodiments, the process 1200 can extract asset identifiers (block 1220). This step involves parsing the monitored communication packet to find specific pieces of data that can be used to uniquely identify the device that sent or received the packet. For example, one of the most common identifiers to be extracted is the device's MAC (Media Access Control) address, which is present in the Layer 2 header of the packet. In another embodiment, deeper packet inspection can be performed to extract identifiers from within industrial protocols themselves, such as a vendor ID or device type code from a CIP (Common Industrial Protocol) packet. It is contemplated that other identifiers could also be extracted, such as an IP address from the Layer 3 header or even a hostname from a DHCP or DNS packet.

In more embodiments, the process 1200 can query a local vendor database with the MAC address (block 1230). Once a MAC address is extracted, this step uses the first half of the address (the Organizationally Unique Identifier, or OUI) to look up the manufacturer of the network interface. For instance, the system can maintain an internal, on-appliance database that maps OUIs to vendor names (e.g., “00:0A: 4F” maps to “Rockwell Automation”). This local query is useful as it does not require an internet connection, which is a common requirement for air-gapped or secure OT environments. It is contemplated that this database could also be a custom, user-supplied database that includes internal vendor assignments, not just public OUI registrations.

In further embodiments, the process 1200 can apply priority-based rules to identifiers (block 1240). This is a crucial step to resolve conflicts when multiple identifiers are extracted for the same device, as some identifiers are more reliable than others. For example, a priority rule can state that a vendor name identified from a deep-packet inspection of an industrial protocol (e.g., “Siemens” from a PROFINET packet) takes precedence over a vendor name identified from the MAC address (e.g., “Intel,” which might just be the manufacturer of the network card). In another embodiment, these rules can be used to combine identifiers. For instance, a rule might state “IF protocol is CIP AND MAC vendor is Rockwell, THEN set device_type to ‘Rockwell PLC’”. It is contemplated that these rules can be user-configurable, allowing an administrator to fine-tune the identification logic for their specific environment.

In additional embodiments, the process 1200 can generate a human-readable asset label (block 1250). This step takes the winning identifiers from the priority rules and formats them into a clear, understandable string for an operator. For example, if the rules determine the vendor is “Siemens” and the protocol is “S7,” this step can generate the label “SiemDns S7 Device.” In an embodiment, the label can be more complex, combining multiple data points, such as “Rockwell PLC—192.168.1.10.” It is contemplated that if no high-confidence identifiers are found, a generic label can be generated, such as “Unknown Device—[MAC Address],” ensuring every device has at least some identifier.

In still more embodiments, the process 1200 can associate the label with the asset in an assets view (block 1260). After the label is generated, it is saved and persistently linked to the asset's unique internal identifier (such as its MAC address). This ensures that any time this asset is seen on the network, its human-readable label is displayed. For instance, this association can be stored in a database or a devices data file, which is then queried by a user interface module to populate the asset list in an “Assets” browser. It is contemplated that this association is also used in other parts of the system; for example, the label “Critical Production Line PLC” can be associated with the asset's pattern of life model, allowing any alerts for that device to be automatically escalated in priority.

The human-readable labels generated by the process 1200 are stored as metadata within the cyber security appliance's own data store and are not written back to the physical assets themselves. The label would be configured to not be attached to the devices in any meaningful way outside of the local system. This virtual label is applied within the context of the current visualization (block 1260). This ensures the asset identification process remains purely passive and non-intrusive, as it never needs to transmit data to the sensitive OT assets it is monitoring.

Although a specific embodiment for a process 1200 for asset identification and labeling for carrying out the various steps, processes, methods, and operations described herein is discussed with respect to FIG. 12, any of a variety of systems and/or processes may be utilized in accordance with embodiments of the disclosure. For example, the query in (block 1230) could be expanded to query more than just a vendor database, such as querying an internal vulnerability database or a configuration management database (CMDB) using the extracted identifiers. The elements depicted in FIG. 12 may also be interchangeable with other elements of FIG. 1-11 and 13-17 as required to realize a particularly desired embodiment.

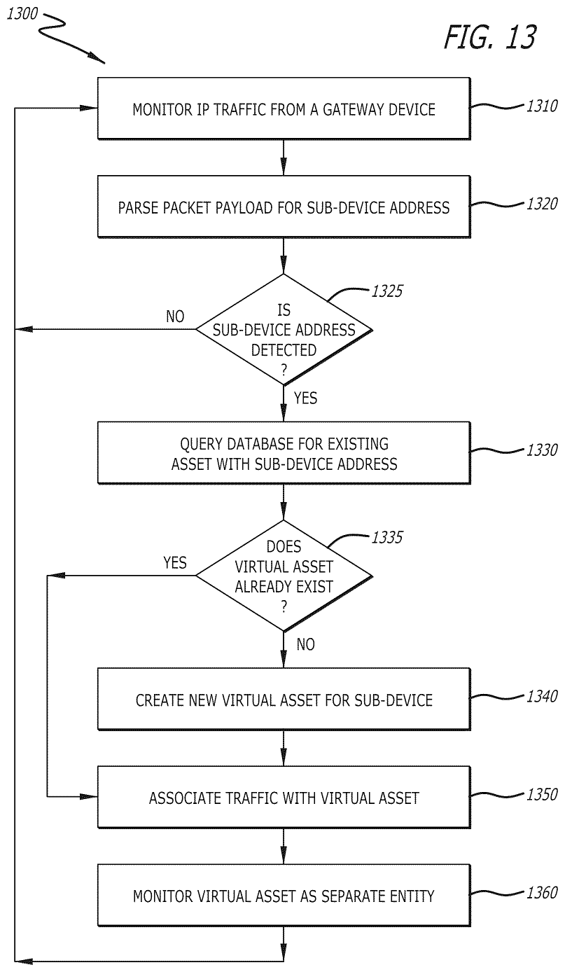

Referring to FIG. 13, a flowchart depicting a process 1300 for sub-device (virtual asset) creation in accordance with various embodiments of the disclosure is shown. In many embodiments, the process 1300 can monitor IP traffic from a gateway device (block 1310). This monitoring is targeted at devices that act as protocol converters, such as an IP-to-Serial gateway or a primary Programmable Logic Controller (PLC) that manages a “daisy-chain” of downstream serial devices. For example, the monitoring can be configured to passively inspect all traffic originating from or destined to the known IP address of this gateway device. In another embodiment, this monitoring can be more specific, applying a deep packet inspection filter to look for traffic using protocols known to encapsulate sub-device communications, such as Modbus TCP or Ethernet/IP, which often contain routing paths to non-IP devices. It is contemplated that this monitoring is continuous, allowing the system to discover new sub-devices as they are added to the serial network.

In a number of embodiments, the process 1300 can parse a packet payload for a sub-device address (block 1320). This step goes beyond looking at the IP headers (which only identify the gateway) and inspects the data payload of the packet itself. For example, in a Modbus TCP packet, the payload contains a “Unit ID” field, which is a common way to address a specific serial device on the other side of the gateway. In a non-limiting example, this parsing can be protocol-specific, with different parsing logic for different industrial protocols that support this type of encapsulation or routing. It is contemplated that this parsing is not limited to a single address; the system can be configured to parse multiple sub-device addressing schemes simultaneously to identify different types of encapsulated traffic.

In more embodiments, the process 1300 can determine if a sub-device address is detected (block 1325). This determination is based on the success of the parsing step. If the packet is a standard IP communication (like a user interface querying the gateway device itself) or does not contain a recognizable sub-device address in its payload, a sub-device address is not detected. If a sub-device address is not detected, the process 1300 can continue to monitor IP traffic from the gateway device (block 1310). However, if the parsing successfully extracts a valid sub-device address (like a Modbus Unit ID), the process determines that a sub-device address is detected. If a sub-device address is detected, the process 1300 can query the database for an existing asset with the sub-device address (block 1330). This query is performed to check if the system is already aware of this specific sub-device. For instance, this query can be against a local asset database using a composite key, such as “[Gateway_IP_Address]: [Sub-Device_Address],” to see if a virtual asset record already exists. It is contemplated that this query is essential for preventing the creation of duplicate assets for the same device.

In further embodiments, the process 1300 can determine if a virtual asset already exists (block 1335). This determination can be based on the results of the query previously done. If the query returns no matching record for the composite key (e.g., “[Gateway_IP_Address]: [Sub-Device_Address]”), the system determines that a virtual asset does not exist. If a virtual asset does not already exist, the process 1300 can create a new virtual asset for the sub-device (block 1340). This creation step involves generating a new entry in the asset database. For example, this new virtual asset record can be assigned its own unique identifier and be given a human-readable label, such as “Virtual Asset-Serial Sensor (via [Gateway_Name]).” In another embodiment, this new virtual asset is also populated with any properties that can be inferred, such as the encapsulated protocol it is using.

However, if the query (from block 1330) finds an existing record for this sub-device, the process 1300 determines that the virtual asset already exists. If the virtual asset already exists, the process 1300 can associate the traffic with the (existing) virtual asset (block 1350). This association is a critical step for attributing the communication to the correct entity. For example, the metadata from the currently monitored packet (such as its timestamp, data size, and any read/write commands) is logged against the virtual asset's record, not the gateway device's record. This allows the system to build a pattern of life model that is specific to the sub-device.

In additional embodiments, the process 1300 can monitor the virtual asset as a separate entity (block 1360). This step is the outcome of the creation and association process, where the newly created or updated virtual asset is now actively monitored. For instance, all future packets parsed with the same sub-device address (from block 1320) will be associated with this virtual asset (in block 1350), allowing the system to build a unique pattern of life for that specific serial sensor. This separate monitoring allows the system to generate highly granular alerts. For example, if this specific sub-device stops communicating (an “absence of expected behavior”), the system can generate a specific operational health alert, such as “Virtual Asset Sensor 7 Offline,” rather than a vague alert like “Gateway Device Anomaly.” It is contemplated that this provides a much more accurate and actionable view of the industrial environment for an operator. The process 1300 can then loop back to continue monitoring traffic from the gateway device (block 1310).

Although a specific embodiment for a process 1300 for sub-device (virtual asset) creation for carrying out the various steps, processes, methods, and operations described herein is discussed with respect to FIG. 13, any of a variety of systems and/or processes may be utilized in accordance with embodiments of the disclosure. For example, the query could also be configured to access a third-party asset management database, not just the local database, to find a matching asset record. The elements depicted in FIG. 13 may also be interchangeable with other elements of FIG. 1-12 and 14-17 as required to realize a particularly desired embodiment.

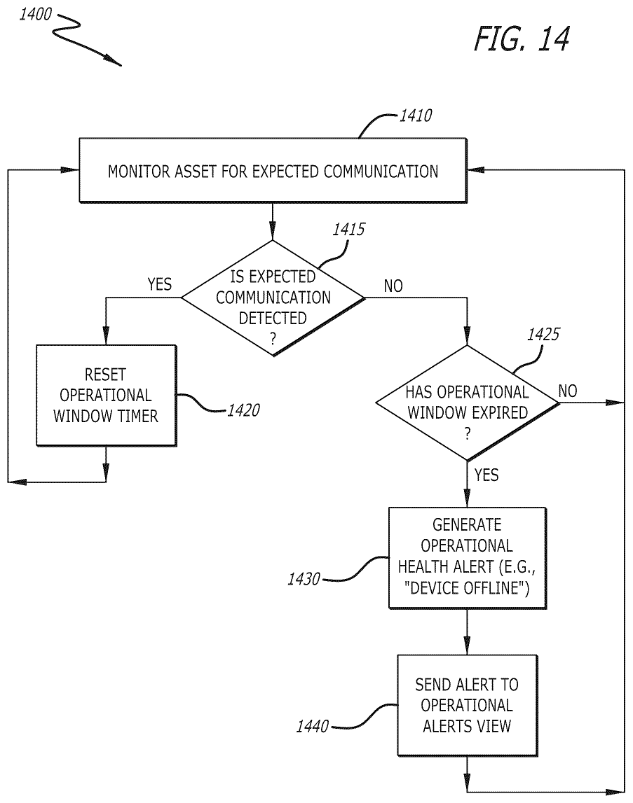

Referring to FIG. 14, a flowchart depicting a process 1400 for detecting device offline status in accordance with various embodiments of the disclosure is shown. The process 1400 for detecting an absence of expected behavior is a useful inventive concept because it can fill the void left by traditional anomaly detection. Previous patterns of life models are configured to detect changes in input, but they won't detect a change to zero of input. The existing appliance, for example, could detect if a device sent new or different data, because if it just stops receiving data, there is no way to classify that and make an alert for it. The process 1400 solves this by explicitly monitoring for a complete lack of activity, allowing the system to alert on a device that has completely stopped communicating.

In many embodiments, the process 1400 can monitor an asset for expected communication (block 1410). This monitoring is a useful part of the absence of expected behavior analysis, where the system checks for the presence of the regular, cyclical traffic that is part of an asset's pattern of life. For example, a Programmable Logic Controller (PLC) might be expected to send a heartbeat packet every five-hundred milliseconds, and this monitoring step is configured to watch for that specific packet. In a non-limiting example, this monitoring can be done by a dedicated sub-process or thread that maintains a “watch list” of critical assets and their expected communication intervals. It is contemplated that this monitoring is not just for any communication, but for specific types of communication that are known to be part of its core function, such as a sensor reporting its value.

In a number of embodiments, the process 1400 can determine if the expected communication is detected (block 1415). This determination is a check to see if the packet that was expected in that instant has arrived. If the expected communication is detected (e.g., the five-hundred millisecond heartbeat packet arrives as scheduled), then the process 1400 can reset the operational window timer (block 1420). However, if the expected communication is not detected within the observation period (e.g., the heartbeat packet is missed), then the process 1400 can determine if the operational window has expired (block 1425).

In more embodiments, the process 1400 can reset the operational window timer (block 1420). This step is performed if the expected communication was successfully detected (in block 1415) and confirms that the asset is online and communicating as expected. This timer represents a grace period during which the device is allowed to be silent before an alert is raised. For example, resetting the timer can be as simple as updating a timestamp in a database associated with the asset's “last seen” status. It is contemplated that this timer value can be different for every asset; a critical safety controller might have a one-second window, while a non-critical device might have a one-hour window. After resetting the timer, the process 1400 can loop back to continue monitoring the asset (block 1410).

In further embodiments, the process 1400 can determine if the operational window has expired (block 1425). This check is performed only if an expected communication was missed. This step compares the current time to the “last seen” timestamp (which was not reset) to see if the total silence has exceeded the configured grace period. If the operational window has not expired (e.g., the device has only been silent for two seconds out of a ten-second window), the process 1400 can loop back to continue monitoring the asset (block 1410), effectively giving the device more time to “check in.” However, if the operational window has expired (e.g., the device has been silent for eleven seconds on a ten-second timer), the process 1400 can generate an operational health alert (block 1430).

In additional embodiments, the process 1400 can generate an operational health alert, for example, “device offline” (block 1430). This alert is the direct result of the device failing to communicate for a duration longer than its configured operational window. This alert is specifically classified as an “operational health” alert to distinguish it from a cybersecurity threat, ensuring it is routed to the correct personnel, such as an operational technology engineer. For instance, the alert payload can contain the asset's human-readable label (e.g., “Main Turbine Sensor”), its IP/MAC address, and the time it was last seen. It is contemplated that this generation step can also include assigning a priority to the alert based on the asset's pattern of life model or user-defined criticality.

In still more embodiments, the process 1400 can send the alert to an operational alerts view (block 1440). Once the alert is generated, it can be delivered to the operator. This step involves formatting the alert and sending it to a specific user interface component, such as the dedicated “alerts” view, which can be separate from the main cyber threat tray. For example, this can be done by writing the alert to a specific alerts data file or by publishing it to a message bus that the user interface is subscribed to. In another embodiment, this step can also involve sending the alert to third-party systems, such as an email to a distribution list or a new ticket in a maintenance management system. After sending the alert, the process 1400 can loop back to continue monitoring the asset (block 1410), which would allow it to generate a “device online” or “alert cleared” notification if the asset resumes communication.

Although a specific embodiment for a process 1400 for detecting device offline status for carrying out the various steps, processes, methods, and operations described herein is discussed with respect to FIG. 14, any of a variety of systems and/or processes may be utilized in accordance with embodiments of the disclosure. For example, the operational window timer could be a dynamic timer that is automatically learned by a machine learning model, rather than a fixed, user-configured value. The elements depicted in FIG. 14 may also be interchangeable with other elements of FIG. 1-13 and 15-17 as required to realize a particularly desired embodiment.

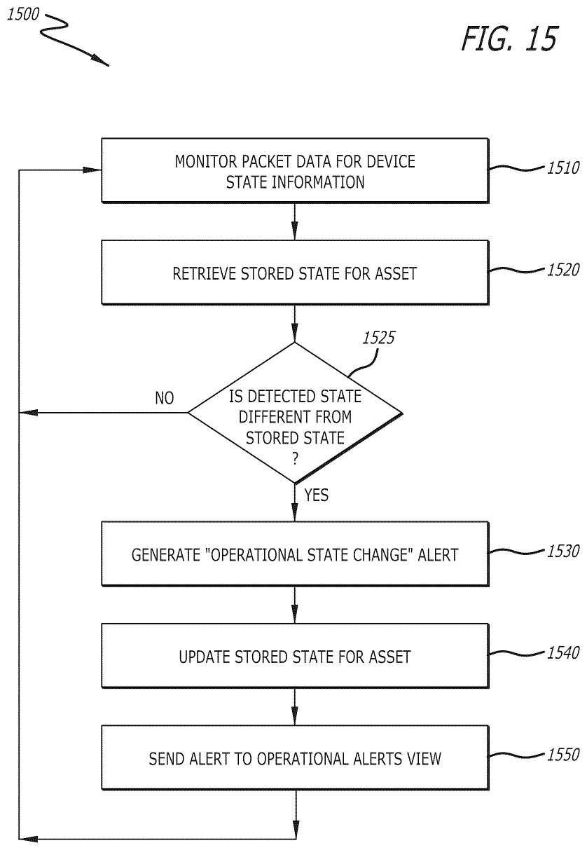

Referring to FIG. 15, a flowchart depicting a process 1500 for an operational state change alert process in accordance with various embodiments of the disclosure is shown. In many embodiments, the process 1500 can monitor packet data for device state information (block 1510). This monitoring can involve performing deep packet inspection on industrial protocols that are known to carry stateful information, such as parsing a PROFINET packet to see if it contains a “Run” or “Stop” command code. In a non-limiting example, this monitoring can also be configured to look for specific values within Modbus registers that correspond to a device's operational mode or status, as defined by the operator or asset vendor. It is contemplated that this monitoring is continuous, allowing the system to capture state changes as they are broadcast over the network in real-time.

In a number of embodiments, the process 1500 can retrieve a stored state for the asset (block 1520). This stored state represents the last known “good” or “normal” operational state that was observed for that specific asset, such as its last recorded state being “Run”. For instance, this retrieval can involve querying a local state data file or a database using the asset's unique identifier (like its MAC address) to find its current recorded state. It is contemplated that if no state is currently stored, for example, if it is a newly discovered device, the system may be configured to proceed directly to establish an initial state.

In more embodiments, the process 1500 can determine if the detected state is different from the stored state (block 1525). If the detected state (from block 1510) is the same as the retrieved state (from block 1520), such as both being “Run”, the process determines no change has occurred and can loop back to continue monitoring packet data (block 1510). However, if the detected state is different from the stored state, for example the detected state is “Stop” while the stored state was “Run”, the process 1500 determines a state change has occurred and can proceed to generate an alert (block 1530). It is contemplated that this comparison can also include a “grace period” or require the new state to be detected multiple times to avoid generating false alerts from transient, temporary state fluctuations.

In further embodiments, the process 1500 can generate an operational state change alert (block 1530). This alert is specifically formatted to be an “operational health” alert, distinguishing it from a cybersecurity threat, and can include details such as the asset's name, the old state (“Run”), and the new state (“Stop”). For instance, this generation step can also assign a priority to the alert based on the type of state change; a change from “Run” to “Maintenance Mode” might be a low priority, while a change from “Run” to “E-Stop” (Emergency Stop) would be a critical priority. It is contemplated that this alert can be generated even for non-standard state changes, such as a device changing its firmware version or configuration, which are also detected as a change in state information.

In additional embodiments, the process 1500 can update the stored state for the asset (block 1540). This step is critical for preventing repeated alerts for the same event; by updating the stored state to the new state (e.g., setting the stored state to “Stop”), the process will not re-alert on the next pass. For example, this update can be a write operation to the same state data file or database that was queried, overwriting the old value with the new one. It is contemplated that this update can also be conditional; for example, an operator may have to “acknowledge” the state change in the user interface before the new state is accepted and stored as the “normal” baseline.

In still more embodiments, the process 1500 can send the alert to an operational alerts view (block 1550). This step involves formatting the alert previously generated and transmitting it to the specific user interface component that is designated for operational health, separate from the main cyber threat tray. For instance, this can be done by publishing the alert to a dedicated message bus or writing it to an alerts data file that the user interface is configured to read from. In another embodiment, this step can also trigger other notifications, such as sending an email or an SMS message to the on-call OT engineer, ensuring the state change is seen immediately. After sending the alert, the process 1500 can loop back to continue monitoring for new state changes (block 1510).

Although a specific embodiment for a process 1500 for an operational state change alert process for carrying out the various steps, processes, methods, and operations described herein is discussed with respect to FIG. 15, any of a variety of systems and/or processes may be utilized in accordance with embodiments of the disclosure. For example, the retrieval of the stored state and the update could be combined into a single read/write operation on a database or state file. The elements depicted in FIG. 15 may also be interchangeable with other elements of FIG. 1-14 and 16-17 as required to realize a particularly desired embodiment.

Referring to FIG. 16, a flowchart depicting a process 1600 for generating architecture visualization data in accordance with various embodiments of the disclosure is shown. The core of the architecture generation is the creation of an extensible data representation. The system is designed to account for any meaningful grouping that matters to one operator, whether that grouping is based on technical criteria (like a protocol) or arbitrary business logic (like a purchase order). This extensible model allows an operator to use the grouping for multiple workflows, such as operational health monitoring, investigative purposes, or to increase alerting thresholds. This flexibility is a differentiator from rigid, static representations that cannot be extended by the user for their own unique purposes.

In many embodiments, the process 1600 can receive labeled IT and OT asset data (block 1610). This data can be provided in real-time from an asset identification process that has been monitoring network traffic. For instance, the data can be a comprehensive list of all discovered devices, including their assigned human-readable labels (e.g., “Rockwell PLC”), device types, and vendors. It is contemplated that this data could also be received as a static list or a batch import, such as by loading a previously saved asset inventory from a database.

A technical differentiator of this on-premises architecture generation (1600) from other systems, such as cloud-based architecture generators, is that the architectures are not configured to do the pruning. Cloud architectures are often more declarative and have natural boundaries like VPCs that allow for logical pruning or severing of graph edges to simplify the view. On-premises OT networks, however, don't really fit into these buckets properly, so this system is designed to visualize the full, complex set of interconnections without this automatic pruning, providing a more raw and accurate depiction of the actual network connections.

A simple analogy for the relationship between architectures and assets is that of folders and files. In this model, the “folders are architectures, and files are devices”. Just as a folder can contain files, an architecture (the “folder”) contains a collection of assets (the “files”). Furthermore, just as a folder can contain other folders, an architecture can be nested to “be another architecture,” allowing for complex, hierarchical groupings (e.g., a “UK” architecture folder containing “London” and “Cambridge” sub-folders).

In a number of embodiments, the process 1600 can analyze communication pathways between assets (block 1620). This analysis is performed to understand the relationships and interconnections between the labeled assets received in the previous step. For example, this analysis can involve building a graph model of which assets are communicating, with what specific protocols, and at what frequency, to understand their pattern of life interconnections. In another embodiment, this analysis could be a simpler look-up of a connection log to determine which devices have recently communicated with each other at least once.

In more embodiments, the process 1600 can determine if a user-defined grouping is provided (block 1625). This determination checks whether an operator has provided specific criteria for building the architecture, or if an automatic grouping should be used instead. This determination is a useful step in applying a grouping or grouping logic to the plurality of assets. This overall process can be accomplished via one of two distinct paths: either by applying a user-defined filter (block 1630) based on an operator's selection, or by applying a system-defined automatic grouping logic (block 1640). For instance, the system can check if the user has manually selected a set of assets from an asset browser or has applied a saved filter from a user interface. If a user-defined grouping is provided, then the process 1600 can apply the user-defined filter to the asset list (block 1630). This filtering applies the operator's specific criteria to the full asset list to create a custom subset of devices. For example, a user could provide a filter for “All Siemens PLCs on Subnet 10.1.1.x,” and this step would isolate only those assets for the visualization. It is contemplated that this filter could also be a simple list of manually selected device identifiers provided by an operator. However, if a user-defined grouping is not provided, then the process 1600 can apply an automatic grouping.

The user-defined grouping (block 1625) is not limited to filtering on shared technical properties that are known to the system. The architecture generation module is an extensible data representation that allows an operator to create a “grouping” of assets can be completely unrelated in every way from a network perspective. For example, a user can arbitrarily select ten different devices and assign them to an architecture simply because they were all on the same purchase order. This allows an operator to create groupings based on their own business logic and contextual information that the system would never be able to gather on its own, yet may be critical for a particular workflow.

The asset groupings are not limited to a static, one-time assignment. The system also supports dynamic assignment to an architecture based on its defined rules. For example, if a user creates an architecture for all “ICS PLC” devices, this grouping is live and dynamic. “When a new device of ICS PLC appears” on the network, the system can automatically detect that it matches the group's criteria and then add it to that architecture, ensuring the grouping is always up to date without manual intervention.

In further embodiments, the process 1600 can apply automatic grouping logic (block 1640). This grouping can be configured to be automatically applied when an operator has not provided a specific filter and instead relies on the system to generate a meaningful, default grouping. For example, this logic can be configured to automatically cluster all assets by their discovered industrial protocol, such as creating one group for all Modbus devices and another for all BACnet devices. In another embodiment, this automatic grouping could cluster assets by a shared characteristic such as their assigned subnet, manufacturer, device type, or logical level in an industrial control systems model.

In additional embodiments, the process 1600 can generate architecture data based on the grouping (block 1650). This step takes the filtered list of and the pathway analysis to create the final dataset for visualization. For instance, this can involve creating a node-edge graph in a standardized format, where each asset in the selected group is a “node” and any communications identified between those assets are “edges.” It is contemplated that this generated data could also be a simple list of the assets in the group, which would be displayed as unconnected nodes if no intra-group communication exists.

The architecture groupings can be configured to function as more than just a visualization; they can create a new meta-layer of grouped entities that may feed back into other analytical modules. The membership of that architecture can become a data point on that device itself. This new meta representation can then be used to enhance other functions, such as to increase priority of alerting if it belongs to a critical user-defined group. The system can even make metamodels in the cybersecurity portion of the system based on any available interconnection between two architectures.

The system internally distinguishes between architectures and diagrams. An architecture is the data model itself, can be described as the clusters of information or logical groupings of devices (e.g., the output of block 1650). A diagram is the separate, visual rendering of that architecture that is presented to the user (e.g., in block 1660). This separation allows the system to use the “architecture” data grouping for non-visual purposes, such as applying new pattern of life models or escalating alert priorities for that group, independent of how it is visualized.

In still more embodiments, the process 1600 can send the data to an architecture rendering component (block 1660). This is the final step where the formatted data (from block 1650) is transmitted to the part of the user interface responsible for drawing the diagram. For example, this data can be sent to a user interface module which then displays the assets and their connections on a dashboard for the operator. In another embodiment, this data could be sent to an Application Programming Interface, allowing a third-party visualization tool or a compliance reporting engine to render or consume the architecture data.

The generated architectures are not just static diagrams; they are manageable objects with access by multiple users with varying levels of control. This is a useful feature for catering to different personas, such as an operational management engineer versus a cyber threat analyst. For example, a high-level manager could have visibility over multiple architectures (e.g., “London site” and “Cambridge site”), while the individual site operators for London and Cambridge can be given admin access to only their own architecture, preventing them from making changes to each other's systems.

Although a specific embodiment for a process 1600 for generating architecture visualization data for carrying out the various steps, processes, methods, and operations described herein is discussed with respect to FIG. 16, any of a variety of systems and/or processes may be utilized in accordance with embodiments of the disclosure. For example, the analysis of communication pathways (block 1620) and the application of grouping logic (block 1640) could be combined into a single step that simultaneously analyzes and groups assets. The elements depicted in FIG. 16 may also be interchangeable with other elements of FIG. 1-15 and 17 as required to realize a particularly desired embodiment.

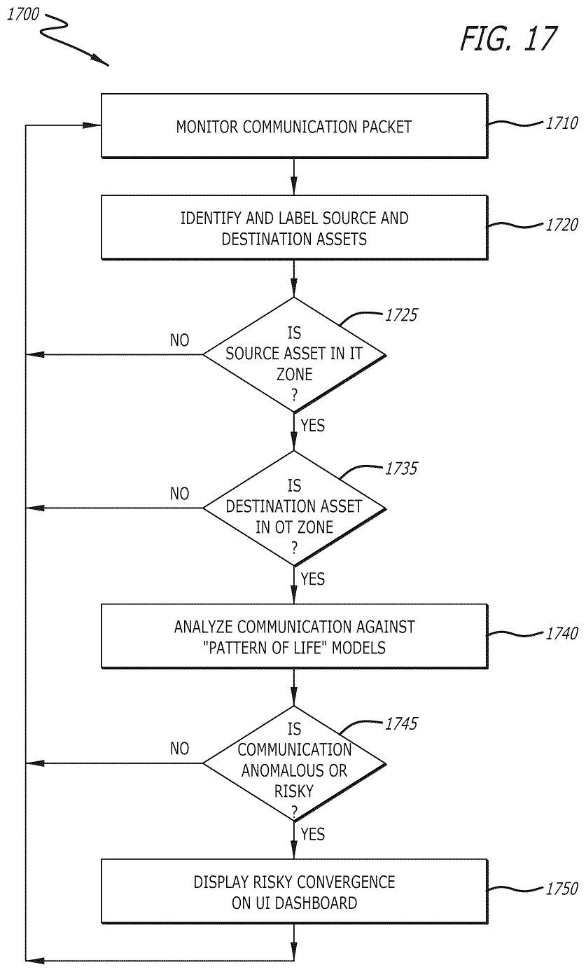

Referring to FIG. 17, a flowchart depicting a process 1700 for monitoring IT/OT convergence in accordance with various embodiments of the disclosure is shown. In many embodiments, the process 1700 can monitor a communication packet (block 1710). This monitoring can be performed passively by a network probe or sensor that is configured to inspect all traffic traversing a specific network segment, such as a core switch or a firewall that separates an Information Technology (IT) network from an Operational Technology (OT) network. In another embodiment, this monitoring can be more targeted, such as by ingesting copies of packets that are specifically forwarded from a gateway or router that manages IT/OT communications. It is contemplated that this monitoring can be continuous and in real-time, allowing the process to analyze every packet that crosses this critical boundary.

In a number of embodiments, the process 1700 can identify and label the source and destination assets of the communication packet (block 1720). This identification can be performed by extracting the source and destination MAC and IP addresses from the packet headers and querying a local asset database to retrieve their human-readable labels and properties. For example, the system can determine that the source is “IT-Workstation-101” (which it knows is in the IT zone) and the destination is “PLC-Compressor-B” (which it knows is in the OT zone). It is contemplated that if an asset is not already labeled, this step can trigger a separate asset identification process to discover and label the new device before proceeding.

In more embodiments, the process 1700 can determine if the source asset is in an IT zone (block 1725). This determination is a critical first check for IT/OT convergence, using the properties of the source asset to check if its pattern of life model or asset tag classifies it as an IT device, such as a corporate server or an engineer's laptop. If it is determined that the source asset is not in an IT zone (e.g., it is an OT-to-OT communication), then the process 1700 can loop back to monitor the next communication packet (block 1710), as this specific flow is not an IT/OT convergence risk. However, if the source asset is in an IT zone, then the process 1700 can proceed to the next check to determine if the destination asset is in an OT zone (block 1735).

In further embodiments, the process 1700 can determine if the destination asset is in an OT zone (block 1735). This check is performed after the source has been confirmed as an IT asset. The system uses the properties of the destination asset to determine if it is a sensitive industrial device, such as a Programmable Logic Controller, Human-Machine Interface, or industrial sensor. If it is determined that the destination asset is not in an OT zone (e.g., it is a standard IT-to-IT communication between two servers), then the process 1700 can loop back to monitor the next communication packet (block 1710), as this is not a cross-zone convergence event. However, if the source is IT and the destination is OT, the process 1700 has confirmed a true IT/OT convergence event and can proceed to analyze the communication against pattern of life models.

In additional embodiments, the process 1700 can analyze the communication against pattern of life models (block 1740). This analysis is a deep inspection of the confirmed IT-to-OT communication. For instance, the system can retrieve the specific pattern of life model for the source IT asset and check if it has ever communicated with this specific OT asset before, or if it is using a protocol (like CIP or Modbus) that it has never used before. In another embodiment, the analysis can be based on the OT asset's model, checking if it normally receives commands from this IT asset. For example, a designated engineering workstation communicating with a PLC is normal, but a corporate file server communicating with that same PLC is highly anomalous. It is contemplated that this analysis can also include parsing the packet payload to check what command is being sent, comparing it against a whitelist of “safe” or “normal” commands for that device pair.

In still more embodiments, the process 1700 can determine if the communication is anomalous or risky (block 1745). This determination is the result of the analysis performed in (block 1740). The system determines if the communication represents a deviation from the established pattern of life models or violates a predefined security rule (e.g., “No IT assets are allowed to write to safety PLCs”). If the communication is not anomalous (e.g., it is a known, legitimate, and expected communication, like an HMI reading data), then the process 1700 can loop back to monitor the next communication packet (block 1710). However, if the communication is anomalous or risky (e.g., it is a new, unexpected connection or involves a dangerous command), then the process 1700 can display the risky convergence on a UI dashboard (block 1750).

In yet further embodiments, the process 1700 can display the risky convergence on a UI dashboard (block 1750). This step serves as the alert mechanism, making the high-risk event visible to an operator. For example, this can involve creating a new alert entry in an “IT/OT CONVERGENCE” widget that lists the source IT asset, the destination OT asset, and the protocol used. In another embodiment, this can involve sending the alert data to an architecture rendering component, which then visually highlights the connection path between the two assets in a topology map, perhaps by drawing a flashing red line. It is contemplated that this step can also trigger an autonomous response, such as sending a command to a firewall to block this specific communication, in addition to displaying the alert. After displaying the alert, the process 1700 can loop back to monitor the next communication packet (block 1710).

Although a specific embodiment for a process 1700 for monitoring IT/OT convergence for carrying out the various steps, processes, methods, and operations described herein is discussed with respect to FIG. 17, any of a variety of systems and/or processes may be utilized in accordance with embodiments of the disclosure. For example, the analysis could also be enhanced by querying a risk management component to determine if the source IT asset has known vulnerabilities, which would increase the risk score of the communication. The elements depicted in FIG. 17 may also be interchangeable with other elements of FIG. 1-16 as required to realize a particularly desired embodiment.

Note, an application described herein includes but is not limited to software applications, mobile applications, and programs routines, objects, widgets, plug-ins that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as Python, C, C++, Java, HTTP, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A module may be implemented in hardware electronic components, software components, and a combination of both. A model, such as a machine learning model composed of neural networks, is a core component of a complex system consisting of hardware storing information and executing instructions and software that is capable of performing its function as discussed herein.

Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A cyber security appliance, comprising:
an operational technology (OT) module configured to receive data from an OT network, wherein the data from the OT network is associated with a plurality of OT assets;
an asset identification module configured to passively monitor the data from the OT network to identify one or more properties of the plurality of OT assets and generate a human-readable label for each of the plurality of OT assets based on the identified one or more properties, where the asset identification module is configured to cooperate with the OT module to identify the one or more properties of the plurality of OT assets;
one or more machine-learning models trained on a normal pattern of life for the plurality of OT assets based on the data received by the OT module;
a comparator module configured to compare the data received from the OT network to the normal pattern of life for the plurality of OT assets obtained from the one or more machine-learning models trained on the normal pattern of life for the plurality of OT assets in order to detect anomalous activity;
an architecture generation module configured to
i) receive the human-readable label for a corresponding OT asset in the plurality of OT assets from the asset identification module;
ii) apply a grouping to the plurality of OT assets to create one or more asset groupings; and
iii) generate architecture visualization data representing the one or more asset groupings utilized with the human-readable label for each of the plurality of OT assets in the asset identification module; and
one or more processing units configured to cooperate with one or more non-transitory computer readable mediums, where when software instructions are used to implement portions of any of the OT module, the asset identification module, the comparator module, the architecture generation module, and the one or more machine-learning models, then the one or more non-transitory computer readable mediums are configured to store the software instructions and the one or more processing units are configured to execute the software instructions.

2. The cyber security appliance of claim 1, further comprising a user interface module configured to receive the architecture visualization data and present the one or more asset groupings on a display with a corresponding human-readable label.

3. The cyber security appliance of claim 1, wherein the grouping is configured to identify a shared characteristic among the plurality of OT assets.

4. The cyber security appliance of claim 3, wherein the shared characteristic is selected from a group consisting of a shared manufacturer, a shared device type, a shared communication protocol, and a shared subnet.

5. The cyber security appliance of claim 1, wherein the grouping comprises a user-defined filter applied to the plurality of OT assets.

6. The cyber security appliance of claim 1, wherein the asset identification module is configured to generate the human-readable label by:
extracting an asset identifier from communication packets associated with an OT asset;
determining a vendor associated with the asset identifier; and
applying a priority-based rule set to the determined vendor and other identified properties to generate the human-readable label.

7. The cyber security appliance of claim 6, wherein the asset identifier is a Media Access Control (MAC) address.

8. The cyber security appliance of claim 1, wherein the comparator module is further configured to:
distinguish between anomalous activity indicative of a cyber threat and anomalous activity indicative of an operational health issue;
in response to detecting the cyber threat, generate a cyber threat alert; and
and in response to detecting the operational health issue, generate an operational health alert.

9. The cyber security appliance of claim 8, wherein the comparator module is configured to generate the operational health alert by:
monitoring an OT asset for an expected communication based on the asset's normal pattern of life;
determining that an operational time window has expired; and
generating the operational health alert in response to detecting an absence of the expected communication within the expired operational time window.

10. The cyber security appliance of claim 8, wherein the comparator module is configured to generate the operational health alert by:
retrieving a stored operational state for an OT asset;
monitoring communication packets from the OT asset to detect a current operational state; and
generating the operational health alert in response to determining the current operational state which is different from the stored operational state.

11. A method for visualizing a network to provide cyber security protection, comprising:
receiving, by a cyber security appliance, data associated with a plurality of operational technology (OT) assets from an OT network;
passively monitoring the data associated with the plurality of OT assets to identify one or more properties of the plurality of OT assets;
generating a human-readable label for each of the plurality of OT assets based on the identified one or more properties;
referencing one or more machine-learning models trained on a normal pattern of life for the plurality of OT assets;
comparing data received from the OT network to the normal pattern of life to detect anomalous activity;
applying a grouping to the plurality of OT assets to create one or more asset groupings;
generating architecture visualization data representing the one or more asset groupings; and
presenting the one or more asset groupings on a graphical user interface dashboard onto a display screen.

12. The method of claim 11, wherein the one or more properties are selected from a group consisting of an observed communication protocol, an identified device type, and a determined subnet.

13. The method of claim 12, wherein generating the human-readable label comprises applying a priority-based rule set to the identified one or more properties.

14. The method of claim 13, wherein the priority-based rule set is configured to generate a specific label by combining two or more of the identified properties selected from the group, and wherein the specific label is prioritized over a generic network identifier associated with the OT asset.

15. The method of claim 11, wherein passively monitoring the data comprises:
parsing an internet protocol (IP) traffic payload from a gateway device to identify a sub-device address associated with an OT asset lacking a direct IP address; and
creating a virtual asset associated with the sub-device address to be monitored as a unique asset.

16. The method of claim 11, wherein applying the grouping comprises:
receiving a user-defined filter from an operator; and
applying the user-defined filter to the plurality of OT assets to create the one or more asset groupings.

17. A non-transitory computer readable medium including software modules to be executed by one or more processing units, the software modules comprising:
an operational technology (OT) module configured to receive data from an OT network, where the data from the OT network is associated with a plurality of OT assets;
an asset identification module configured to passively monitor the data from the OT network to identify one or more properties of the plurality of OT assets and generate a human-readable label for each of the plurality of OT assets based on the identified one or more properties, where the asset identification module is configured to cooperate with the OT module to identify the one or more properties of the plurality of OT assets;
a comparator module configured to compare data received from the OT network to normal pattern of life for the plurality of OT assets obtained from one or more machine-learning models trained on a normal pattern of life for the plurality of OT assets in order to detect anomalous activity;
an architecture generation module configured to:
apply a grouping to the plurality of OT assets to create one or more asset groupings; and
generate architecture visualization data representing the one or more asset groupings; and
a user interface module configured to receive the architecture visualization data and present the one or more asset groupings on a display with a corresponding human-readable label.

18. The non-transitory computer readable medium of claim 17, wherein the asset identification module is configured to generate the human-readable label by:
extracting an asset identifier from communication packets;
querying a locally stored database with the asset identifier to determine a vendor; and
applying a priority-based rule set to the determined vendor and other identified properties to generate the human-readable label.

19. The non-transitory computer readable medium of claim 17, wherein the comparator module is further configured to:
generate a cyber threat alert in response to detecting anomalous activity indicative of a cyber threat; and
generate an operational health alert in response to detecting anomalous activity indicative of an operational health issue.

20. The non-transitory computer readable medium of claim 19, wherein the user interface module is further configured to present both the cyber threat alert and the operational health alert on a unified dashboard displayed on a common display screen.
